(19) United States
(12) Patent Application Publication
(10) Pub. No.: US 2026/0229681 A1
(43) Pub. Date: Aug. 6, 2026

(54) MULTI-SPRING COMPRESSION PLATE SYSTEM

(71) Applicant: Saint-Gobain Performance Plastics Pampus GmbH, Willich (DE)

(72) Inventors: Benedikt Klapheck, Duesseldorf (DE); Jan Fluegge, Cologne (DE); André Gabener, Essen (DE); Simon John Parker, Bristol (GB)

(21) Appl. No.: 19/532,714

(22) Filed: Feb. 6, 2026

Related U.S. Application Data
(60) Provisional application No. 63/755,109, filed on Feb. 6, 2025.

(51) Int. Cl. H01M 50/291; F16F 3/02; H01M 50/209; H01M 50/242

(52) U.S. Cl. CPC H01M 50/291; F16F 3/023; H01M 50/209; H01M 50/242; F16F 2224/0208

(57) ABSTRACT

A multi-spring compression plate is provided for use in a compression pad. A compression pad may include a pair of opposing multi-spring compression plates. Each multi-spring compression plate includes a plurality of springs. A spring may include an elongate spring body with a spring perimeter surface structured to define at least part of an aperture perimeter. The aperture perimeter may define a u-shaped aperture in the multi-spring compression plate. A spring may be a bridge spring associated with two or more connection to a multi-spring compression plate. The multi-spring compression plates may include a plurality of support regions defined by adjacent pairs of springs with one or more elongate stiffening ribs extending along a first direction at least partially through one or more of the plurality of support regions.

### CROSS-REFERENCE TO RELATED APPLICATIONS

This application claims priority to U.S. Provisional Patent Application No. 63/755,109, filed February 6, 2025, the contents of which are incorporated herein by reference in their entirety.

### FIELD OF INVENTION

The present disclosure relates to systems, apparatuses, and methods for compressive structures, and more particularly to multi-spring compression plates configured to provide pressure distribution, such as in battery cell compression systems.

### BACKGROUND

Battery systems are becoming increasingly prevalent in various applications, including electric vehicles, consumer electronics, and energy storage systems. These battery systems may include multiple batteries that are each made of multiple battery cells arranged together to achieve desired voltage and capacity specifications. These batteries may also be referred to as battery modules or battery packs. Such battery systems are charged and discharged to keep the battery system at a desired voltage to support ongoing use. The charging and/or discharging may cause a battery cell(s) to undergo expansion and/or contraction due to the electrochemical process(es) within the battery cell(s).

The inventors have identified many deficiencies and problems associated with existing methods, apparatus, and systems related to battery system dimensional change during charging and/or discharging. Through applied effort, ingenuity, and innovation, many of these identified deficiencies and problems have been solved by developing solutions that are configured in accordance with embodiments of the present disclosure, many examples of which are described in detail herein.

### SUMMARY

Various embodiments of the present disclosure are directed to apparatuses, systems, and for multi-spring compression plates. The characteristics as well as additional features, functions, and details of various embodiments are described below. The claims set forth herein further serve as a summary of this disclosure.

### BRIEF DESCRIPTION OF FIGURES

Various embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. The terms “illustrative,” “example,” and “exemplary” are used to be examples with no indication of quality level. Like numbers refer to like elements throughout.

FIG. 1A is a top view of a first embodiment of a multi-spring compression plate in accordance with various example embodiments of the present disclosure.

FIG. 1B is a top view of a second embodiment of a multi-spring compression plate in accordance with various example embodiments of the present disclosure.

FIG. 1C is a perspective view of a third embodiment of a multi-spring compression plate in accordance with various example embodiments of the present disclosure.

FIG. 2 is a top view of a compression pad in accordance with various example embodiments of the present disclosure.

FIG. 3 is a section view of the compression pad of FIG. 2 taken along section lines A-A in accordance with various example embodiments of the present disclosure.

FIG. 4 is a detail view of the compression pad of FIG. 2 taken along detail circle B in accordance with various example embodiments of the present disclosure.

FIG. 5 is a detail view of the section view of the compression pad of FIG. 3 taken along detail circle C in accordance with various example embodiments of the present disclosure.

FIG. 6 is a detail side view of the compression pad of FIG. 2 defined by detail circle B in accordance with various example embodiments of the present disclosure.

FIG. 7 is a perspective view of a pair of multi-spring compression plates of a compression pad shown in a partially exploded position in accordance with various example embodiments of the present disclosure.

FIG. 8 is a detail perspective view of the compression pad of FIG. 2 defined by detail circle B in accordance with various example embodiments of the present disclosure.

FIG. 9 is a perspective view of a multi-spring compression plate positioned proximate a heat transfer plate in accordance with various example embodiments of the present disclosure.

FIG. 10 is a side view of a pair of multi-spring compression plates of a compression pad in accordance with various example embodiments of the present disclosure.

FIG. 11A is a top view of a multi-spring compression plate structured to define differential width spring designs in accordance with various example embodiments of the present disclosure.

FIG. 11B is a first perspective view of the multi-spring compression plate of FIG. 11A in accordance with various example embodiments of the present disclosure.

FIG. 11C is a second perspective view of the multi-spring compression plate of FIG. 11A in accordance with various example embodiments of the present disclosure.

FIG. 12 is a perspective view of a pair of multi-spring compression plates structured to define differential width spring designs in accordance with various example embodiments of the present disclosure.

FIG. 13 is a perspective view of a first embodiment of a spring structured for use in a multi-spring compression plate in accordance with various example embodiments of the present disclosure.

FIG. 14 is a perspective view of a second embodiment of a spring structured for use in a multi-spring compression plate in accordance with various example embodiments of the present disclosure.

FIG. 15 is a perspective view of a third embodiment of a spring structured for use in a multi-spring compression plate in accordance with various example embodiments of the present disclosure.

FIG. 16 is a perspective view of a fourth embodiment of a spring structured for use in a multi-spring compression plate in accordance with various example embodiments of the present disclosure.

FIG. 17 is a perspective view of a fifth embodiment of a spring structured for use in a multi-spring compression plate in accordance with various example embodiments of the present disclosure.

FIG. 18 is a perspective view of a sixth embodiment of a spring structured for use in a multi-spring compression plate in accordance with various example embodiments of the present disclosure.

FIG. 19 is a perspective view of a first pair of springs structured for use in a compression pad in accordance with various example embodiments of the present disclosure.

FIG. 20 is a perspective view of a second pair of springs structured for use in a compression pad in accordance with various example embodiments of the present disclosure.

FIG. 21 is a perspective view of a seventh embodiment of a spring structured for use in a multi-spring compression plate in accordance with various example embodiments of the present disclosure.

FIG. 22 is a perspective view of a third pair of springs structured for use in a compression pad in accordance with various example embodiments of the present disclosure.

FIG. 23 is a perspective view of three pairs of springs structured for use in a compression pad in accordance with various example embodiments of the present disclosure.

FIG. 24 is a perspective view of an eighth embodiment of a spring structured for use in a multi-spring compression plate in accordance with various example embodiments of the present disclosure.

FIG. 25 is a perspective view of three pairs of springs structured for use in a compression pad in accordance with various example embodiments of the present disclosure.

FIG. 26 is a perspective view of a pair of springs structured for use in a compression pad in accordance with various example embodiments of the present disclosure.

FIG. 27 is a perspective view of three pairs of springs structured for use in a compression pad in accordance with various example embodiments of the present disclosure.

FIG. 28 is a perspective view of a first battery system in accordance with various example embodiments of the present disclosure.

FIG. 29 is an exploded perspective view of a portion of a second battery system in accordance with various example embodiments of the present disclosure.

FIG. 30 is a perspective view of a portion of a third battery system in accordance with various example embodiments of the present disclosure.

FIG. 31 illustrates an example sequence diagram of operations for use of a method for using a multi-spring compression plate in accordance with various example embodiments of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Battery cells undergo dimensional changes during charging and discharging cycles, both in the immediate operation and over their lifetime. For a battery cell, there is a need to mitigate immediate growth and shrinkage as well as a need for compensation of gradual growth and/or shrinkage over lifetime. This phenomenon, sometimes referred to as "cell breathing," results from electrochemical processes within the cells that cause expansion and contraction of the cell volume. The expansion pattern of prismatic and pouch cells tends to be non-uniform, often exhibiting a bulbous profile during charging cycles. Managing the dimensional changes of battery cells presents various technical challenges. Uneven pressure distribution on battery cell surfaces during expansion and contraction cycles may contribute to degradation mechanisms within the cells. For instance, non-uniform pressure on the electrolyte may promote dendritic growth of lithium, which can penetrate the solid electrolyte and potentially create internal short circuits, leading to thermal events. Compression systems for battery cells may also serve thermal management functions, such as maintaining contact between cells and thermal management components to facilitate heat transfer during operation. The integration of compression and thermal management functions introduces additional design considerations.

Additionally, in battery systems without compression management, the dimensional changes of battery cells during charging and discharging cycles may cause relative movement between adjacent cells and their associated electrical connections. This relative movement can subject electrical connections to repeated mechanical stress as a cell moves during expansion and contraction. Over time, this cyclic loading may contribute to fatigue and/or failure in electrical connections. In various embodiments, compression systems of multi-spring compression plates and/or compression pads positioned between battery cells may help mitigate this relative movement by providing a compliant interface that accommodates dimensional changes while maintaining consistent positioning of the cells. By reducing the magnitude of relative displacement between cells, the lifetime of electrical connections with a battery cell assembly is extended and there is a reduced likelihood of fatigue-related electrical failures within the battery system.

Various battery types may be subject to a myriad of dimensional changes which can be challenging for consistent compression management. For example, solid state battery systems may need higher compression values and more space for changing dimensions when “breathing” during charging and discharging cycles than other battery type systems. Various embodiments discussed herein are configured to adapt to such system variability and particularly to accommodate the high-compression requirements of solid state battery systems.

In various embodiments, maintaining battery cell compression within an optimal range may be beneficial for battery cell longevity and performance. Compression that is too low may contribute to increased aging of the battery cells, while compression that is too high may cause damage to the cells. A uniform distribution of compressive force across battery cell surfaces may be desirable, with a constant force over the range of compression being a factor in the arrangement and configurations of springs of various embodiments. The multi-spring compression plates and compression pads described herein may address this by providing compression plate profiles that are configured to distribute forces uniformly across battery cell surfaces throughout expansion and contraction cycles.

Various embodiments of the present disclosure address technical challenges associated with battery cell compression systems, including addressing technical challenges that are presented over the lifetime of the battery system. The multi-spring compression plates and compression pads described herein provide solutions for managing dimensional changes in battery cells during charging and discharging cycles while encouraging a more uniform pressure distribution across battery cell surfaces.

Various undesirable compression mechanisms may produce localized pressure concentrations when battery cells expand non-uniformly during charging cycles. Other undesirable compression mechanisms may produce compress forces well below 0.3 MPa, which is insufficient to serve many battery cell systems including those having solid state battery cells.

In contrast to such undesirable mechanisms, the multi-spring compression plates of various embodiments of the present disclosure include a compression plate body defining a plurality of elongate spring bodies arranged in a pattern to distribute compressive forces across the compression plate surface rather than concentrating forces at discrete points. More particularly, in some embodiments, an example multi-spring compression plate may include a compression plate body comprising a plurality of elongate spring bodies, wherein each elongate spring body of the plurality of elongate spring bodies comprises a spring perimeter surface that is structured to define at least part of an aperture perimeter of a spring shaping aperture extending through the compression plate body. The compression plate body further comprises a plurality of support regions defined between adjacent pairs of the plurality of elongate spring bodies, and one or more elongate stiffening ribs defined by the compression plate body within one or more of the plurality of support regions extending along a first direction at least partially between a first adjacent pair of the plurality of elongate spring bodies.

Additionally, various embodiments are structured to maintain structural rigidity of the compression plate or pad while permitting spring deflection. The compression plate bodies of the present disclosure may include one or more elongate stiffening ribs defined within one or more of the plurality of support regions extending along a first direction at least partially between a first adjacent pair of the plurality of elongate spring bodies. Compression plate bodies may further comprise one or more elongate stiffening cross-ribs defined by the compression plate body within the plurality of support regions, wherein each of the one or more elongate stiffening cross-ribs extends along a second direction transverse to the first direction, which may enhance structural rigidity while providing contact surfaces for springs of a reciprocally opposing multi-spring compression plate.

In some embodiments, one or more multi-spring compression plates may be configured with differential width spring designs to tune the compression plate(s) in anticipation of non-uniform pressure distributions that may be produced by expanding/retracting battery systems. The differential widths of the elongate spring bodies may be structured to provide differential spring constants across the length or width of a multi-spring compression plate. For example, in some embodiments, elongate spring bodies may define larger widths positioned in a central region of a multi-spring compression plate to provide higher spring constants in such central region. Elongate spring bodies formed outside of the central region, e.g., in peripheral regions, may define smaller widths thereby providing lower spring constants in these regions. This arrangement of springs having differential widths across the lengths or widths of opposing multi-spring compression plates enables compression pads of such embodiments to provide uniform distribution of compression reaction forces across the entire surface of the compression pad when compression occurs, compensating for any non-uniform expansion characteristics of the battery cells during charging and discharging cycles. As another example, in some embodiments, elongate spring bodies may define smaller widths positioned in a central region of a multi-spring compression plate to provide lower spring constants in such central region. Elongate spring bodies formed outside of the central region, e.g., in peripheral regions, may define larger widths thereby providing higher spring constants in these regions.

Various embodiments may be further configured to integrate thermal management with compression management functionality. For example, thermal management functionality may be served by maintaining contact between battery cells and heat transfer components throughout battery system expansion and contraction cycles. In some embodiments, a heat transfer plate may be bonded or coupled to the multi-spring compression plate(s), wherein the combined stiffness may exceed the sum of the stiffness of the individual components, which may reduce pressure concentrations acting on battery cells during compression while facilitating heat transfer.

In various embodiments, compression pads may be specifically designed and configured to provide thermal and electrical properties that facilitate desired thermal management and electrical conductivity within a battery system. For example, the multi-spring compression plates forming the compression pad may be fabricated from materials having or configured for thermal conductivity characteristics that enable heat transfer from adjacent battery cells through the compression pad structure. In various embodiments, the compression plate bodies and springs may be formed from metallic materials such as aluminum or copper alloys that provide thermal pathways for conducting heat away from battery cell surfaces during charging and discharging operations.

In various embodiments, the compression pad may also be designed to function as a thermal interface that distributes heat across the surface area of the compression pad, reducing localized thermal “hot spots” on battery cell surfaces. The electrical conductivity of the compression pad materials may, in some cases, provide electrical conductivity, electrical isolation, or both.

In some embodiments, a compression pad may be designed to provide grounding or shielding functions within the battery module. In other embodiments, the compression pad may be configured with pathways or vias that are configured to conduct charge or current to one or more specific locations within a battery.

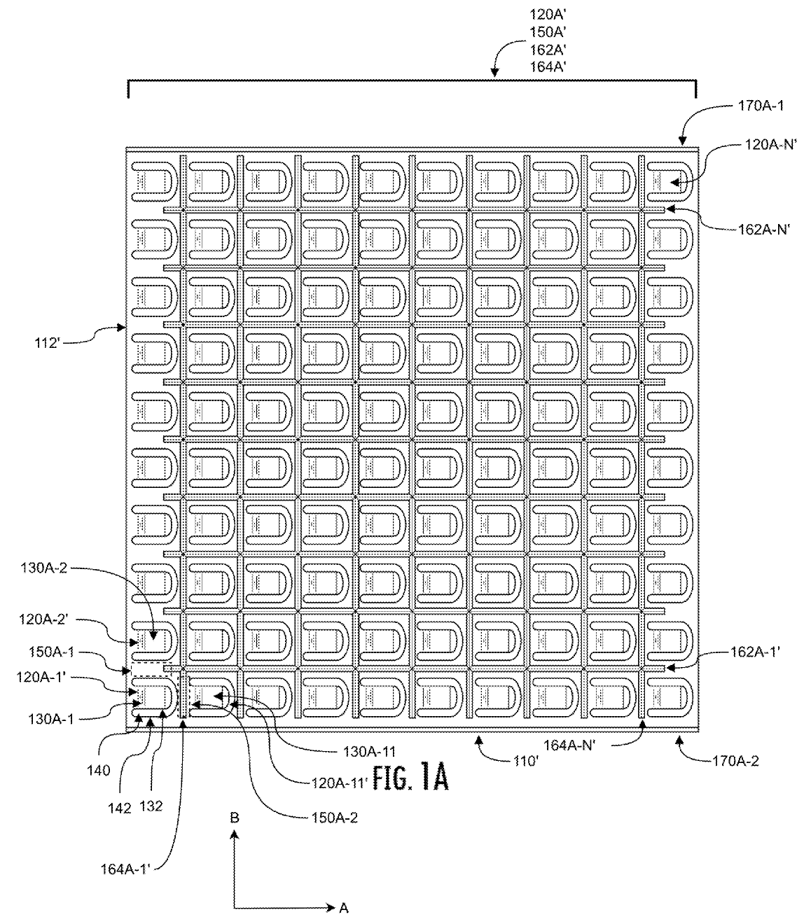

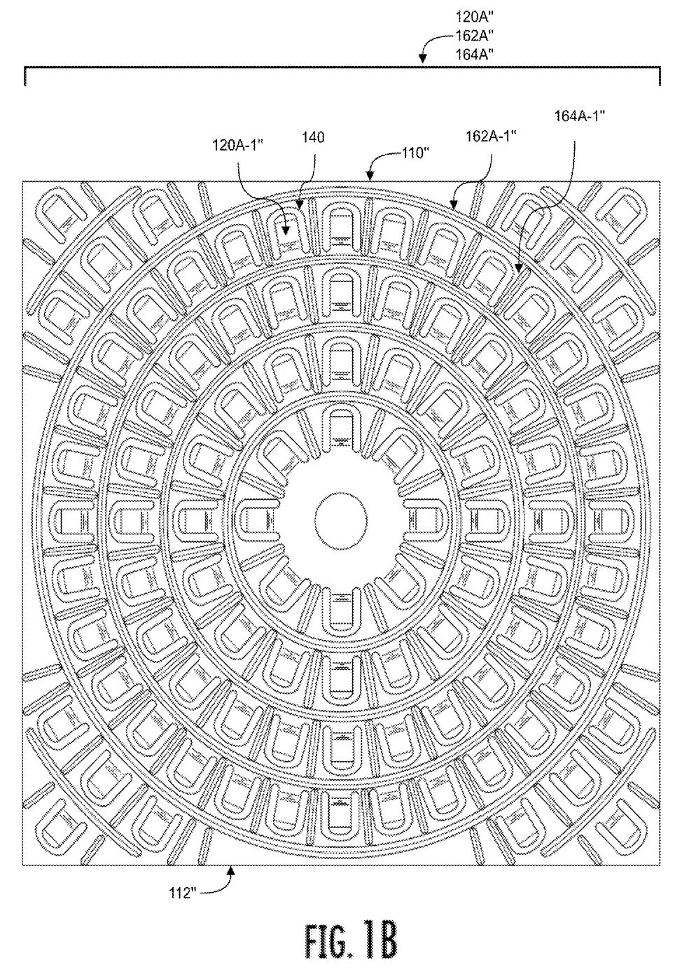

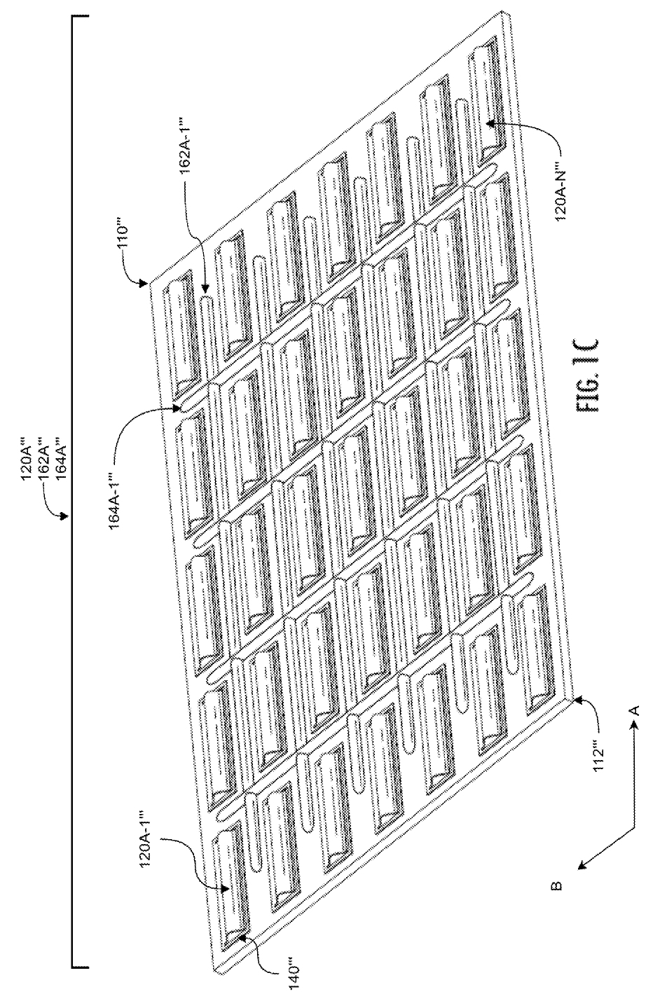

FIGS. 1A and 1B illustrate top views of two different multi-spring compression plates 110’, 110’’ structured in accordance with various example embodiments of the present disclosure. FIG. 1C illustrates a perspective view of a different third multi-spring compression plates 110’’’ structured in accordance with various example embodiments of the present disclosure.

Each of the illustrated embodiments of FIGS. 1A-1C comprise, respectively, compression plate bodies 112’, 112’’, 112”’ defining a plurality of springs (e.g., 120A-1’ to 120A-N’, 120A-1’’ to 120A-N’’, 120A-1’” to 120A-N’”) arranged across the surface of the respective multi-spring compression plates 110’, 110’’, or 110’’’. For ease of reference, when referring collectively to a plurality of springs distributed over the surface of the compression plate bodies 112’, 112’’, or 112”’, the present disclosure uses the element label 120A’, 120A”, or 120A’” (indicated by callout brackets in the respective figures). For ease of reference, when referring collectively to a support region of on the compression plate bodies 112’, the present disclosure uses the element label 150A’, to refer to such respective collections of support regions (also indicated by callout brackets in the respective figures).

For illustration reasons similar to those provided above, when referring collectively to an elongate stiffening ribs distributed over the surface the compression plate bodies 112’, 112’’, or 112’’’, the present disclosure uses the element labels 162A’, 162A’’, or 162A’’’ to refer to such respective collections of elongate stiffening ribs(also indicated using callout brackets). For ease of reference, when referring collectively to an elongate stiffening cross-rib, the present disclosure will use the element labels 164A’, 164A’’, or 164A’’’ to refer to such respective collections of elongate stiffening cross-ribs(also illustrated using callout brackets).

In the first embodiment of the multi-spring compression plate 110’ of FIG. 1A, the second embodiment of the multi-spring compression plate 110’’ of FIG. 1B, and the third embodiment of the multi-spring compression plate 110’’’, the plurality of springs 120A’, 120A’’, and 120’’’ are structured as “finger wave” springs as described herein. In other multi-spring compression plate embodiments, some or all of the plurality of springs are structured as “bridge” springs as described herein.

In various embodiments, although not shown, multi-spring compression plates may include different combinations of spring types, orientations, and/or arrangements. For example, a multi-spring compression plate may include finger wave springs in one region and bridge springs in another region, or may include springs oriented in different directions across the compression plate body. Such embodiments also include one or more of an elongated elongate stiffening ribs and/or elongate stiffening cross-ribs of the types discussed below configured in various directions and cross directions depending on the design requirements of a particular battery system or packaging environment.

Returning to FIG. 1A, the depicted multi-spring compression plate 110’ comprises a compression plate body 112’ having a plurality of springs 120A’ (e.g., 120A-1’-120N-1’). The plurality of springs 120A’ are arranged in a pattern, such as a grid pattern, arranged along a first direction illustrated along arrow A and a second direction illustrated along arrow B.

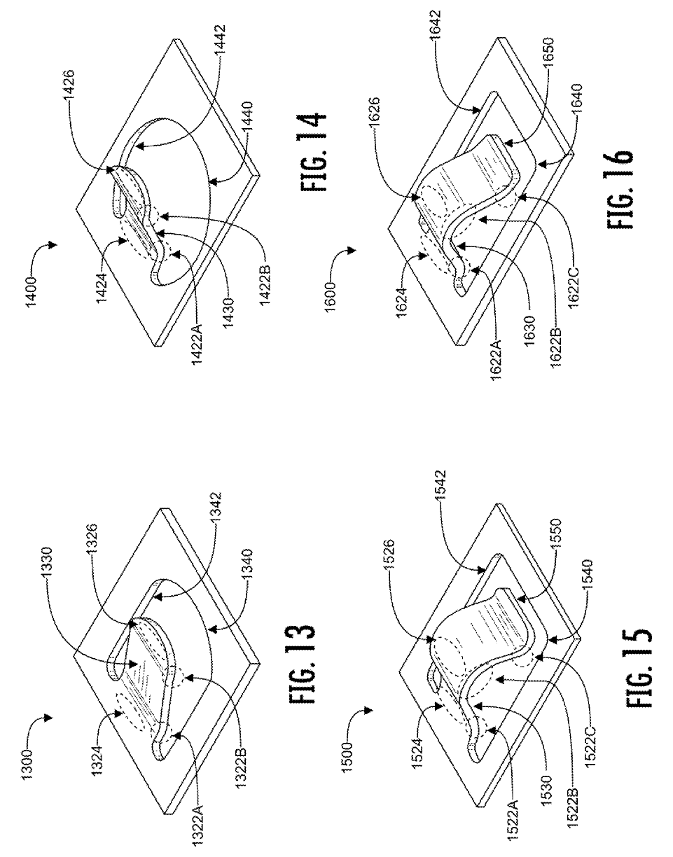

The depicted plurality of springs 120A’ are structured as “finger wave” springs 120A-1’ – 120N-1’, which embodiments of finger wave springs are described herein, including with respect to FIGS. 13-16. In the depicted embodiment, the plurality of springs 120A’ each define an elongate spring body 130 defining a spring perimeter surface 132, which is structured to define at least part of an aperture perimeter 142 of a spring shaping aperture 140 extending through the compression plate body 112. In some embodiments, the spring shaping aperture is an aperture that is formed or cut (e.g., die-cut) in compression plate body to define an individual spring body (e.g., elongate spring body 130) such that a portion of the perimeter of the spring shaping aperture (e.g., aperture perimeter 142) defines at least a portion of the perimeter surface of the spring body (e.g., spring perimeter surface 132).

In various embodiments, such as the embodiment illustrated in FIG. 1A, the spring shaping aperture 140 is u-shaped so as to define an elongate spring body. Such u-shaped spring shaping aperture is thus structured to define an aperture perimeter having a concave aperture perimeter portion. For example, the inner portion of the u-shaped spring shaping aperture that defines the elongate spring body may define a first concave aperture perimeter portion while the outer portion of the u-shaped spring shaping aperture that is positioned opposite to such inner portion may define a second concave aperture perimeter portion.

In various embodiments, such as illustrated in FIG. 1A, the plurality springs 120A’ can be oriented in a first direction along arrow A (or along a second direction along arrow B) as shown. However, in other embodiments, it will be appreciated that a plurality of springs may be oriented in a variety of other directional combinations as discussed herein. While the plurality of springs 120A’ of FIG. 1A are illustrated as finger wave springs, it will be appreciated that other types of springs may be used, including bridge springs.

The multi-spring compression plate 110’ of FIG. 1A includes one or more support regions. For example, there may be a first support region 150A-1 and a second support region 150A-2. In various embodiments, the support regions are located between adjacent pairs springs, such as between adjacent springs 120A-1’ and 120A-2’. In the depicted embodiment, a first support region 150A-1 is defined between elongate spring bodies 130A-1, 130A-2 of springs 120A-1’ and 120A-2’, and a second support region 150A-2 is defined between elongate spring bodies 130A-1, 130A-11 of springs 120A-1’ and 120A-11’. The first support region 150A-1 and the second support region 150A-2 provide areas within which elongate stiffening rib 162A-1’ and elongate stiffening cross-ribs 164A-1’ may, respectively, be located.

The multi-spring compression plate 110’ includes elongate stiffening ribs extending in one or more directions. The depicted elongate stiffening ribs may extend in a first direction along arrow A and also in a second direction B. The elongate stiffening rib(s) extending in a second direction B may be referred to as an elongate stiffening cross-ribs 164A’ due to the configuration of an elongate stiffening cross-rib crossing one or more support regions 150 and one or more elongate stiffening rib(s) 162A’ in the first direction A. In various embodiments, the first direction along arrow A and a second direction along arrow B may be orthogonal as shown. The elongate stiffening ribs 162A’ can be defined by the compression plate body 112’ within one or more plurality of support regions 150A’. For example, a first elongate stiffening rib 162A-1’ may extend in a first direction along arrow A through a plurality of support regions. In various embodiments, a second elongate stiffening rib of elongate stiffening cross-rib 164A-1’ can extend in a second direction along arrow B through a plurality of support regions.

The elongate stiffening ribs 162A’ and elongate stiffening cross-ribs 164A’ may be defined or formed within the compression plate body 112’ to extend in the respective first and second directions and configured to define contact surfaces for springs of a second, opposing multi-spring compression plate as discussed in FIG. 2 below. The elongate stiffening ribs 162A’ and elongate stiffening cross-ribs 164A’ may be structured to enhance the structural rigidity of the compression plate body 112’. In some embodiments, one or more of the elongate stiffening ribs and elongate stiffening cross-ribs may be continuous in shape. Alternatively or additionally, one or more of the elongate stiffening ribs and elongate stiffening cross-ribs may vary in shape along the surface of the compression plate body, such as having a rib that defines flattened regions along the length of the rib and/or ribs that raised or lowered relative other portions of the rib. These varied rib regions may serve as opposing rib contact areas such as where an opposing spring may make contact with the respective rib.

The compression plate body 112’ illustrated in FIG. 1A defines a rectangular shape. In various embodiments, the compression plate bodies discussed herein may define a variety of different shapes, including but not limited to rectangular shapes, circular shapes, oval shapes, or irregular shapes. Such shapes may be associated with the application or use case the multi-spring compression plate 110’ is used in. For example, in some embodiments, the compression plate body shape may be based on the shape and/or size of a battery module that a compression pad including the multi-spring compression plate 110’ is used in.

The multi-spring compression plate 110’ includes one or more rails along one or more edges of the multi-spring compression plate 110’. For example, a first rail 170A-1 is located on a first edge of the multi-spring compression plate body 112 of and a second rail 170A-2 is located on a second edge of the multi-spring compression plate body 112. The one or more rails can facilitate assembly with a cooperating, opposing multi-spring compression plate (not illustrated) to form a compression pad. The one or more rails may provide structural support for the multi-spring compression plate 110’.

In various embodiments, the distribution of springs 120 across the compression plate body 112 provides a spring pattern configured to distribute compressive forces across the multi-spring compression plate 110’. When a first multi-spring compression plate 110' and a second multi-spring compression plate are configured as a compression pad, the compression pad may uniformly distributed pressure across the compression pad.

FIG. 1B is a top view of a second embodiment of a multi-spring compression plate 110’’ in accordance with various example embodiments of the present disclosure. The multi-spring compression plate 110’’ has a plurality of springs 120A’’ arranged in a radial or circular arrangement across the surface of the multi-spring compression plate 110’’. The plurality of springs 120A’’ may be positioned in concentric rings extending outward from a center of the multi-spring compression plate 110’’. The plurality of springs 120A’’ may be finger wave springs (e.g., 120A-1’’), such as described herein. The plurality of springs 120A’’ may extend to the edges of the multi-spring compression plate 110’’.

One or more elongate stiffening ribs, such as a first elongate stiffening rib 162A-1’’, may be arranged in a circular configuration adjacent to the circular arrangement of the plurality of springs 120A’’. Other than its configuration in a circular shape as shown, the first elongate stiffening rib 162A-1’ of FIG. 1B will be appreciated to be an elongate stiffening rib as described herein. The multi-spring compression plate 110’’ further includes elongate stiffening cross-ribs 164A’’, including the first elongate stiffening cross rib 164A-1’’, extending along radial directions outward from a center of the multi-spring compression plate 110’’ and arranged in support regions defined between adjacent pairs of the plurality of springs 120A’’.There may be a plurality of stiffening ribs arranged in concentric rings between adjacent pairs of the plurality of springs 120A’’ or next to outermost springs of the plurality of springs 120A’’. In various embodiments, the plurality of springs 120A’’ may be oriented in different directions, such as with elongate spring bodies extending radially outward from the center, tangentially along the concentric rings, or in combinations thereof. The spring shaping apertures, such as spring shaping aperture 140’, may be configured to accommodate the radial positioning of the plurality of springs 120A’’ within the arrangement of the plurality of springs 120A’’ of FIG. 1B. While the multi-spring compression plate 110’’ is illustrated as defining a square shape, it will be appreciated that the multi-spring compression plate 110’’ may define another shape, such as a circular shape.

FIG. 1C is a perspective view of a third embodiment of a multi-spring compression plate 110’’’ in accordance with various example embodiments of the present disclosure. The multi-spring compression plate 110’’’ comprises a compression plate body 112’’ having a plurality of springs 120A’’’ arranged in a grid arrangement across the surface of the multi-spring compression plate 110’’’. The depicted plurality of springs 120A’’’ are structured as “finger wave” springs 120A-1’’’ – 120N-1’’’, which embodiments of finger wave springs are described herein, including with respect to FIGS. 24-27. The plurality of springs 120A’’’ may be arranged or configured in rows and columns extending along a first direction A and a second direction B. The second direction B may be transverse to the first direction A. The multi-spring compression plate 110’’’ includes elongate stiffening ribs 162A’’’, including the first elongate stiffening rib 162A-1’’’, extending along the first direction within support regions defined between adjacent pairs of the plurality of springs 120A’’’. The multi-spring compression plate 110’’’ further includes elongate stiffening cross-ribs 164A’’’, including the first elongate stiffening cross rib 164A-1’’’, extending along the second direction B within support regions defined between adjacent pairs of the plurality of springs 120A’’’. The elongate stiffening ribs 162A’’’ and the elongate stiffening cross ribs 164A’’’ may intersect within to form a grid-like pattern, which may enhance the structural rigidity of the compression plate body 112’’’ while also providing contact surfaces for springs of an opposing multi-spring compression plate when configured in a compression pad.

While FIGS. 1A-1C illustrate uniformly structured springs 120A-1’ – 120A-N’, 120A-1’’’ arranged in respective multi-spring compression plates 110’, 110’’, 110’’’, various embodiments have one or more of the springs that may be varied from each other by having one or more of a different material grade, material thickness, spring width, spring height, compression angle(s), surface size, etc. Similarly, while the elongate stiffening ribs and elongate stiffening cross ribs are illustrated as uniform, one or more of the elongate stiffening ribs and/or elongate stiffening cross ribs may vary in configuration, shape, size, length, uniformity, material grade, material thickness, rib width, rib height, rib angle(s), rib shape, rib flatness, rib surface(s), etc. Various embodiments may be configured or arranged for the stiffness of a multi-spring compression plate (e.g., 110’, 110’’, 110’’’), a compression pad, one or more springs (e.g., 120A’, 120A’’, 120A’’’), one or more elongate stiffening ribs, and/or elongate stiffening cross ribs to be varied in one or more directions. For example, a multi-spring compression plate 110 (e.g., 110’, 110’’, 110’’’) may be varied in stiffness from corner-to-corner (e.g., stiff top right, soft bottom left, and gradient in between) and/or from side to side (e.g., top to bottom, left to right).

In various embodiments, the plurality of springs (e.g., 120A’, 120A’’, 120A’’’) of a multi-spring compression plate (e.g., 110’, 110’’, 110’’’) may be configured in different orientations across a compression plate body (e.g., 112’, 112’’, 112’’’). For example, the springs may be oriented in a right to left configuration, wherein respective the elongate spring bodies extend along a horizontal axis of the compression plate body. Alternatively, the springs may be oriented in an up to down configuration, wherein the elongate spring bodies extend along a vertical axis of the compression plate body. In some embodiments, the compression plate body may include a combination of spring orientations, such as a first plurality of springs oriented in a right to left configuration and a second plurality of springs oriented in an up to down configuration. In various embodiments, the orientations of springs may be varied in regular patterns (e.g., every other spring is in a different orientation or configuration). The variations may be for a varied orientation pattern by row, column, or for one or more portions of the entire multi-spring compression plate body. In various embodiments, the orientation of the springs may be arranged based on the anticipated direction of expansion forces from an adjacent battery cell(s), the desired distribution of compressive forces across the multi-spring compression plate body, and/or the geometric constraints of the battery module in which the multi-spring compression plate body is to be installed. In various embodiments, alternating spring orientations across different regions of the compression plate body may also provide enhanced force distribution characteristics for applications where battery cell expansion exhibits directional variation.

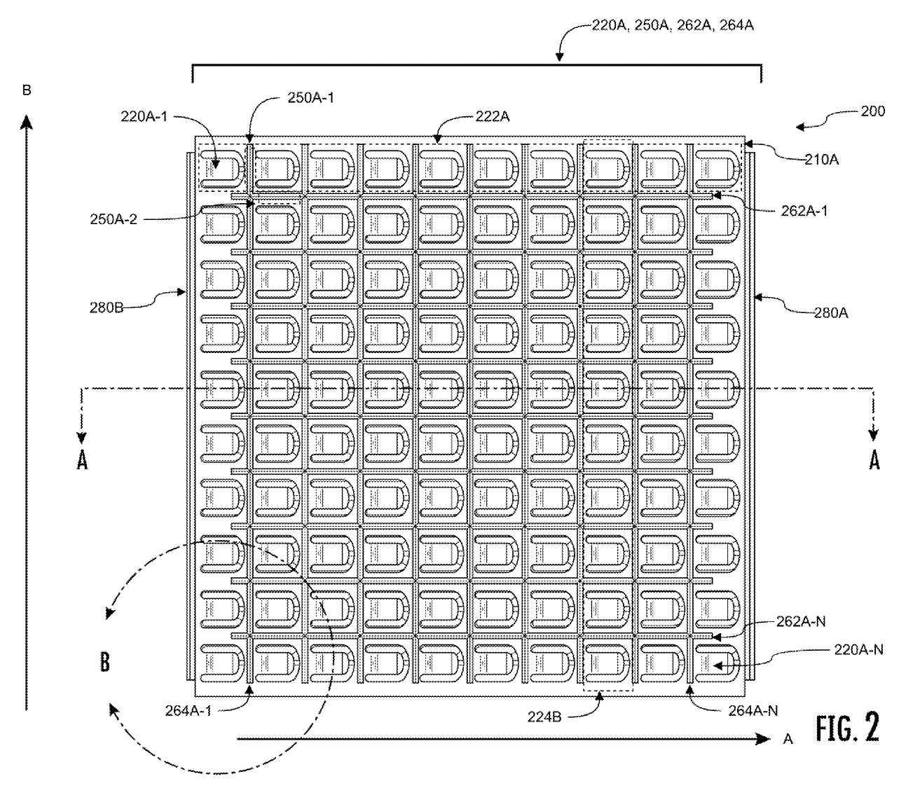

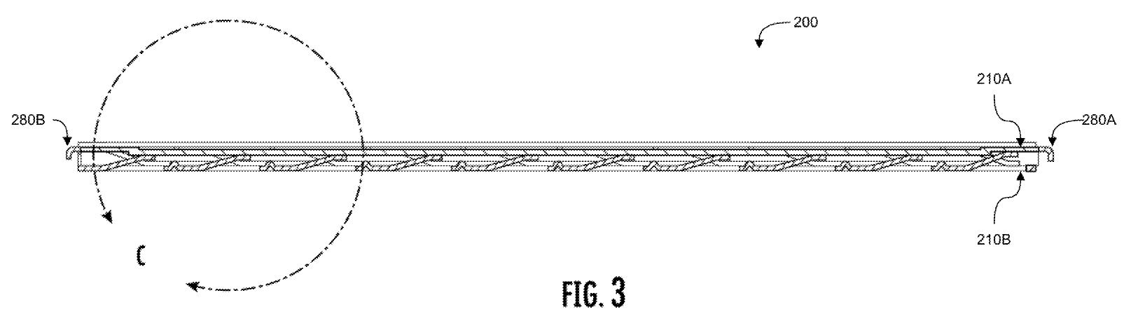

FIG. 2 is a top view of a compression pad 200 in accordance with various example embodiments of the present disclosure. Section line A-A defines the section associated with FIG. 3, which provides a section view of the depicted compression pad 200. Detail circle B is associated with FIG. 4, which provides a detail view one corner segment of the compression pad 200.

For ease of reference, when referring collectively to a plurality of springs distributed over the surface of the compression plate bodies 212A, the present disclosure uses the element label 220A to refer to such respective collections of springs, such as illustrated with a bracket that may be used to refer to the plurality of springs of FIGS. 2 and 4. For ease of reference, when referring collectively to a support region of on the compression plate bodies 212A, the present disclosure uses the element label 250A, to refer to such respective collections of support regions, such as illustrated with a bracket that may be used to refer to the plurality of support regions. For ease of reference, when referring collectively to an elongate stiffening ribs distributed over the surface the compression plate bodies 212, the present disclosure uses the element label 262A to refer to such respective collections of elongate stiffening ribs, such as illustrated with a bracket that may be used to refer to the plurality of elongate stiffening ribs of FIGS. 2 and 4. For ease of reference, when referring collectively to an elongate stiffening cross-rib, the present disclosure will use the element label 264A to refer to such respective collections of elongate stiffening cross-ribs, such as illustrated with a bracket that may be used to refer to the plurality of elongate stiffening cross-ribs of FIGS. 2 and 4.

The compression pad 200 depicted in FIG. 2 comprises a first multi-spring compression plate 210A positioned atop an opposing second multi-spring compression plate (illustrated but not separately called out in this view). The compression pad 200 is configured with a uniform distribution of a plurality of springs, including the plurality of springs 220A of the first multi-spring compression pad 210A. The plurality of springs 220A are arranged in a grid pattern across the surface of the first multi-spring compression plate 210A. The grid pattern may be arranged in first direction and a second direction as shown. In various embodiments, the arrow A corresponds to a first direction and arrow B corresponds to a second direction transverse to the first direction. Spring row 222A is arranged in the first direction A while spring column 224B is arranged in the second direction B. The word “row” as used herein refers to a grouping of the plurality of springs 220A that are arranged in a similar direction, such as the first direction A. The word “column” as used herein refers to a grouping of the plurality springs 220A that are arranged in a similar direction, such as the second direction B, that is transverse to a first direction A.

While a compression pad 200 may include a first multi-spring compression plate 210A positioned over an opposing second multi-spring compression plate, various embodiments include a compression pad formed from a single multi-spring compression plate (e.g., 110’, 110’’, 110’’’, 210A).

The first multi-spring compression plate 210A and an opposing second multi-spring compression plate (not illustrated) are configured as twin spring plates with interleaved plurality of springs. In various embodiments, the plurality of springs 220A from the first multi-spring compression plate 210A act on the elongate stiffening ribs and/or elongate stiffening cross-ribs located in the support regions between the plurality of springs on the opposing second multi-spring compression plate. The interleaved arrangement avoids points of high load and therefore reduces pressure concentrations across the compression pad 200 when a compression is applied in a third direction, such in a Z axis (not illustrated, but into or out of the illustration).

The compression pad 200 includes a first compression pad mounting bracket 280A positioned along a first edge of the first multi-spring compression plate 210A and a second compression pad mounting bracket 280B positioned along an opposing second edge of the first multi-spring compression plate 210A. The first compression pad mounting bracket 280A and the second compression pad mounting bracket 280B facilitate mounting and positioning of the compression pad 200 within a battery module or other application requiring pressure distribution.

In various embodiments, a compression pad 200 may be configured for a specific compressive strength or a range of compressive strengths. For example, a compression pad 200 may be structured to present a compression strength in a range of 0.5 – 5.0 MPa to adjacently positioned battery cells. In another example, a compression pad 200 may be structured to present a compression strength in a range of 1.5 – 3.0 MPa to adjacently positioned battery cells. Compression pads 200 structured to provide compression strengths in a range between 0.5 – 5.0 MPa may be particularly useful in battery system stacks having solid state battery cells. In some embodiments, the compression strength presented by a compression pad 200 may be uniform over each side of the compression pad 200.

FIG. 3 is a section view of the compression pad of FIG. 2 taken along section lines A-A in accordance with various example embodiments of the present disclosure. Detail C is associated with FIG. 5, which provides a detail view of one segment of the compression pad 200.

The compression pad 200 includes a first multi-spring compression plate 210A coupled with an opposing second multi-spring compression plate 210B. The first multi-spring compression plate 210A and the second multi-spring compression plate 210B are positioned in an opposing facing or opposing arrangement to form the compression pad 200. The plurality of springs of the first multi-spring compression plate 210A and the plurality of springs of the second multi-spring compression plate 210B are oriented toward one another.

The compression pad 200 includes a first compression pad mounting bracket 280A positioned along a first edge of the compression pad 200 and a second compression pad mounting bracket 280B positioned along an opposing second edge of the compression pad 200. The first compression pad mounting bracket 280A and the second compression pad mounting bracket 280B extend from the compression pad 200 and facilitate mounting and positioning of the compression pad 200 within a battery module or other application requiring pressure distribution.

FIG. 4 is a detail view of the compression pad of FIG. 2 taken along detail circle B in accordance with various example embodiments of the present disclosure. The illustrated portion depicts a detailed view of the arrangement of springs 220A and support regions 250A within the first multi-spring compression plate 210A.

The portion of the compression pad 200 includes a first spring 220A-1, a second spring 220A-2, and an eleventh spring 220A-11 arranged in a grid pattern. The first spring 220A-1 has an elongate spring body 230A-1 that defines a spring shaping aperture 240 extending through the compression plate body. The spring shaping aperture 240 has a u-shaped configuration with the elongate spring body 230A-1 structured to define at least part of an aperture perimeter of the spring shaping aperture 240. The springs of the plurality of springs 220A (e.g., 220A-1, 220A-2, 220A-11 ...) may each have a first shape, size, and spring constant. A first elongate stiffening rib 262B-1 of the opposing multi-spring compression plate 210B (not illustrated in FIG. 4) is visible through the spring shaping aperture 240. This illustrates how the first spring 220A-1 is aligned for engagement with the first elongate stiffening rib 262B-1 of the opposing multi-spring compression plate 210B (not illustrated in FIG. 4).

The illustrated portion depicts an adjacent pair of springs 220A including a first adjacent pair of springs 422A-1 and a second adjacent pair of springs 422A-2. The first adjacent pair of springs 422A-1 comprises the first spring 220A-1 and the second spring 220A-2 positioned adjacent to one another in a second direction along a second direction along arrow B. The second adjacent pair of springs 422A-2 comprises the first spring 220A-1 and the eleventh spring 220A-11 positioned adjacent to one another in a first direction along arrow A that is transverse to the second direction.

A first elongate stiffening rib 262A-1 is within a support region 250A-1 between the first adjacent pair of springs 422A-1 and extends along the first direction at least partially between the elongate spring body 230A-1 of the first spring 220A-1 and the elongate spring body 230A-2 of the second spring 220A-2. A first elongate stiffening cross rib 264A-1 is within the support region 250A-2 between the second adjacent pair of springs 422A-2 and extends along the second direction at least partially between the elongate spring body 230A-1 of the first spring 220A-1 and the elongate spring body 230A-11 of the eleventh spring 220A-11.

The first multi-spring compression plate 210A and an opposing second multi-spring compression plate 210B are configured to be opposing with interleaved springs. The plurality of springs 220A from the first multi-spring compression plate 210A act on the first elongate stiffening rib 262B-1 on the opposing second multi-spring compression plate 210B. In various embodiments, the first elongate stiffening rib 262A-1 has a width extending in the second direction along the B arrow, and the first elongate stiffening cross rib 264A-1 has a width extending in the first direction along the A arrow. These widths may be configured to provide contact surfaces sized to receive the elongate spring bodies of the respective opposing multi-spring compression plate during compression.

FIG. 5 is a detail view of the section view of the compression pad of FIG. 3 taken along detail circle C in accordance with various example embodiments of the present disclosure. The illustrated portion depicts the interleaved arrangement of the plurality of springs 220A between the first multi-spring compression plate 210A and the second multi-spring compression plate 210B that together form the compression pad 200. The compression pad 200 comprises the first multi-spring compression plate 210A positioned in an opposing arrangement with the second multi-spring compression plate 210B.

The second multi-spring compression plate 210B includes a first spring 520B-1, a second spring 520B-2, and a third spring 520B-3 extending from the second multi-spring compression plate 210B toward the first multi-spring compression plate 210A. Each of the first spring 520B-1, the second spring 520B-2, and the third spring 520B-3 define a spring compression angle 522 relative to its respective support surface. The second spring 520B-2 defines a first spring compression angle 522B-1 and a second spring compression angle 522B-2 for the elongate spring body 530B-2 of the second spring 520B-2. A spring compression angle 522B-2 is structured to define, along or in part, the compressive engagement between a respective spring (e.g., 520B-2) and a reciprocally aligned elongate stiffening rib (e.g., 262A-1) of the opposing first multi-spring compression plate 210A. The first multi-spring compression plate 210A includes a first elongate stiffening rib 262A-1 that provides a contact surface for receiving the springs of the second multi-spring compression plate 210B during compression. A spring 520B-2 has a spring contact surface 526B-2 of the elongate spring body 530B-2 that makes contact with the first elongate stiffening rib 262A-1. The spring contact surface 526B-2 is an elongate stiffening rib-engagement surface that is configured to slideably engage the reciprocally aligned elongate stiffening rib 262A-1 of the opposing multi-spring compression plate 210B. In various embodiments, the spring contact surface 526 may be an elongate stiffening rib-engagement surface configured to slideably engage the reciprocally aligned elongate stiffening rib of an opposing multi-spring compression plate.

The illustrated portion of the second multi-spring compression plate 210B includes a first support region 550B-1 and a second support region 550B-2 defined between respective adjacent pairs springs 520B-1 and 520B-2 and also 520B-2 and 520B-3. A first cross elongate stiffening rib 264B-1 is positioned within the first support region 552B-1 of the second multi-spring compression plate 210B.

The springs of the second multi-spring compression plate 210B engage with the first multi-spring compression plate 210A at a spring contact surface 526. The spring contact surface 526 represents the interface where the elongate spring body 530 engages the elongate stiffening rib 262A-1 of the first multi-spring compression plate 210A.

In various embodiments, the interleaved configuration, where the springs 520B from the second multi-spring compression plate 210B act on the support regions and elongate stiffening ribs of the first multi-spring compression plate 210A provides for avoidance of high compression loads on a compression pad 200 and reduces pressure concentrations across the compression pad 200 when compression is applied.

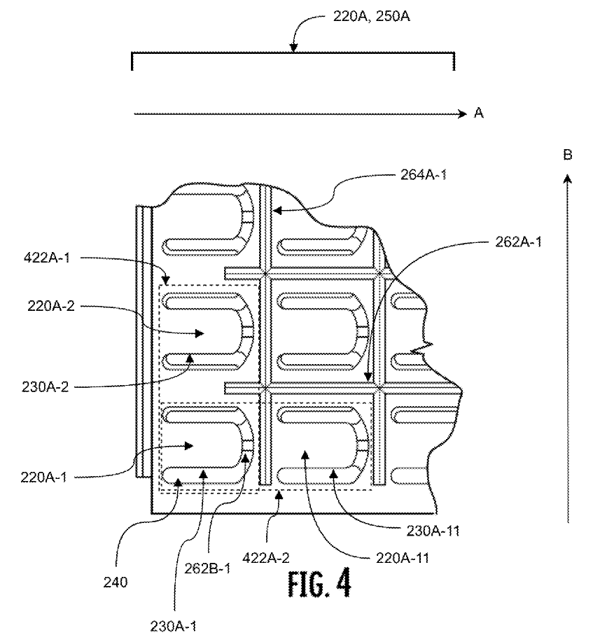

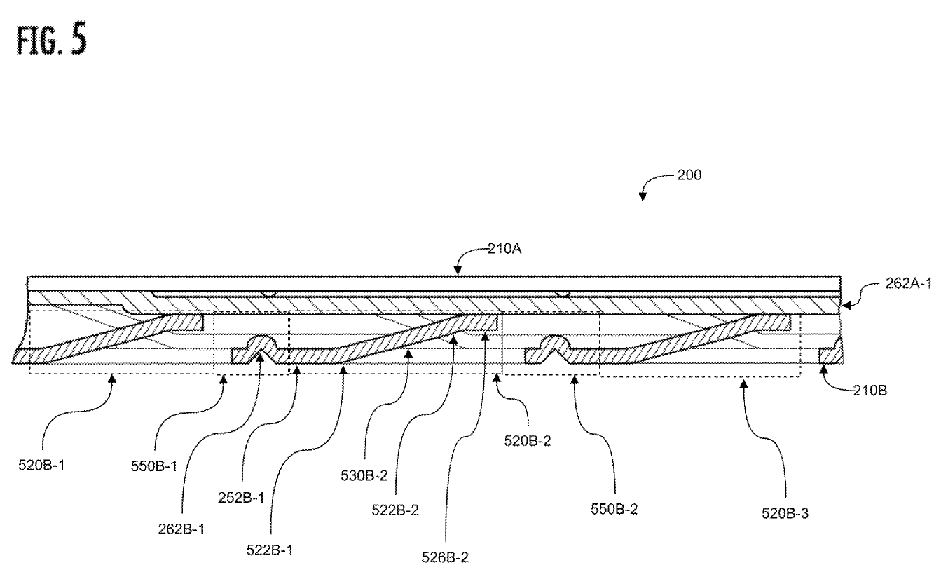

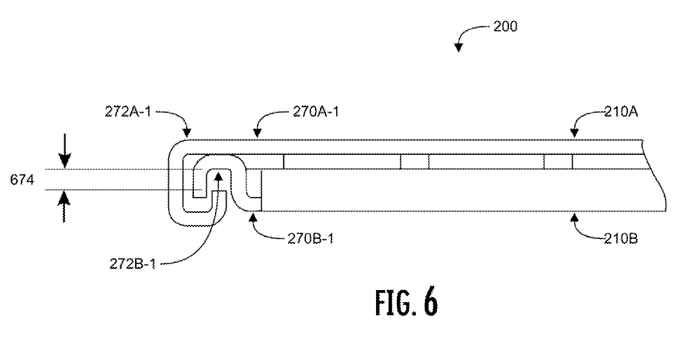

FIG. 6 is a detail side view of the compression pad of FIG. 2 defined by detail circle B in accordance with various example embodiments of the present disclosure. The illustrated portion depicts the coupling arrangement via rails 270A-1, 270B-1 between the first multi-spring compression plate 210A and the second multi-spring compression plate 210B that together form the compression pad 200. While FIG. 6 illustrates a coupling arrangement via rails 270A-, 270B-1, it will be appreciated that various embodiments do not require the rails.

The compression pad 200 comprises the first multi-spring compression plate 210A positioned in an opposing arrangement with the second multi-spring compression plate 210B. The first multi-spring compression plate 210A includes a first rail 270A-1 positioned along an edge of the first multi-spring compression plate 210A. The second multi-spring compression plate 210B includes a first rail 270B-1 positioned along a corresponding edge of the second multi-spring compression plate 210B. The first rail 270A-1 of the first multi-spring compression plate 210A and the first rail 270B-1 of the multi-spring compression plate 210B are configured to couple or engage one another to facilitate controlled assembly of the first multi-spring compression plate 210A and the second multi-spring compression plate 210B into a compression pad 200.

The first rail 270A-1 includes a first rail coupling 272A-1 that engages with a first rail coupling 272B-1 of the first rail 270B-1. The first rail coupling 272A-1 and the first rail coupling 272B-1 provide a sliding interface that permits relative displacement between the first multi-spring compression plate 210A and the second multi-spring compression plate 210B along a compression axis. This sliding engagement allows the compression pad 200 to accommodate a travel distance 674 corresponding to battery cell expansion and contraction during charging and discharging cycles.

The rail coupling arrangement between the first rail 270A-1 and the first rail 270B-1 provides multiple functions within the compression pad 200. The first rail coupling 272A-1 and the first rail coupling 272B-1 allow controlled assembly of the first multi-spring compression plate 210A and the second multi-spring compression plate 210B while permitting the required displacement or movement defined by the travel distance 674 to compensate for battery cell expansion. The rail coupling arrangement provides contributory stiffness to the compression pad 200 assembly to prevent high pressure concentrations acting on battery cells. Additionally, the first rail 270A-1 and the first rail 270B-1 restrict movement to ensure the compression pad 200 remains assembled even in an unloaded condition and provides extra stiffness in a lateral direction transverse to the compression axis.

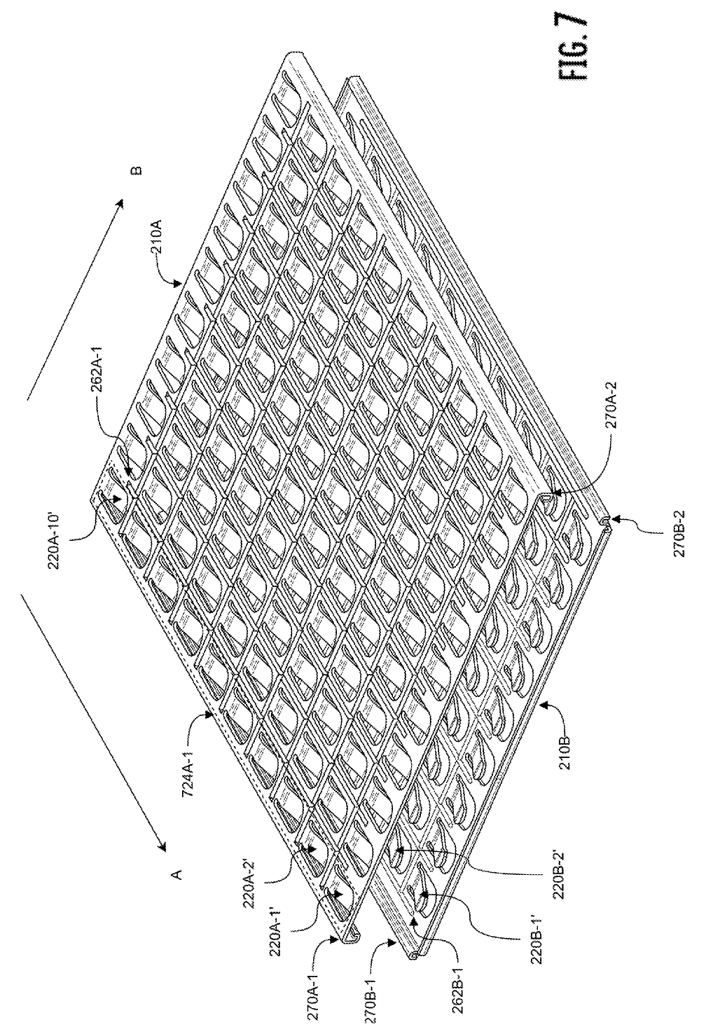

FIG. 7 is a perspective view of a pair of multi-spring compression plates of a compression pad shown in a partially exploded position in accordance with various example embodiments of the present disclosure. The illustrated view depicts an exploded view of the first multi-spring compression plate 210A positioned in an opposing arrangement with the second multi-spring compression plate 210B to form a compression pad 200. The first multi-spring compression plate 210A and the second multi-spring compression plate 210B are configured as twin spring plates with interleaved springs, wherein the plurality of springs from one multi-spring compression plate act on the support regions between the springs on the opposing multi-spring compression plate.

The first multi-spring compression plate 210A includes a first plurality of springs 724A-1 comprising the first spring 220A-1’, the second spring 220A-2’, and the springs to the tenth spring 220A-10’ extending from the first multi-spring compression plate 210A toward the second multi-spring compression plate 210B. The first elongate stiffening rib 262A-1 is positioned within a support region between adjacent springs of the first multi-spring compression plate 210A and provides a contact surface for receiving springs from the second multi-spring compression plate 210B during compression.

The second multi-spring compression plate 210B includes the first spring 220B-1’ and the second spring 220B-2’ extending from the second multi-spring compression plate 210B toward the first multi-spring compression plate 210A. The first elongate stiffening rib 264B-1 is positioned within a support region of the second multi-spring compression plate 210B and provides a contact surface for receiving the first plurality of springs 724A-1 from the first multi-spring compression plate 210A.

The interleaved configuration illustrated in FIG. 7 demonstrates how the first plurality of springs 724A-1 of the first multi-spring compression plate 210A aligns with the first elongate stiffening rib 264B-1 of the second multi-spring compression plate 210B when assembled. Similarly, the first spring 220B-1 and the second spring 220B-2 of the second multi-spring compression plate 210B align with the first elongate stiffening rib 262A-1 of the first multi-spring compression plate 210A. This interleaved arrangement avoids points of high load and reduces pressure concentrations across the compression pad when compression is applied.

The first multi-spring compression plate 210A includes the first rail 270A-1 and the second rail 270A-2 positioned along opposing edges of the first multi-spring compression plate 210A. The second multi-spring compression plate 210B includes the first rail 270B-1 and the second rail 270B-2 positioned along corresponding edges of the second multi-spring compression plate 210B. The first rail 270A-1 engages with the first rail 270B-1, and the second rail 270A-2 engages with the second rail 270B-2 to couple the first multi-spring compression plate 210A and the second multi-spring compression plate 210B together while permitting relative displacement along a compression axis.

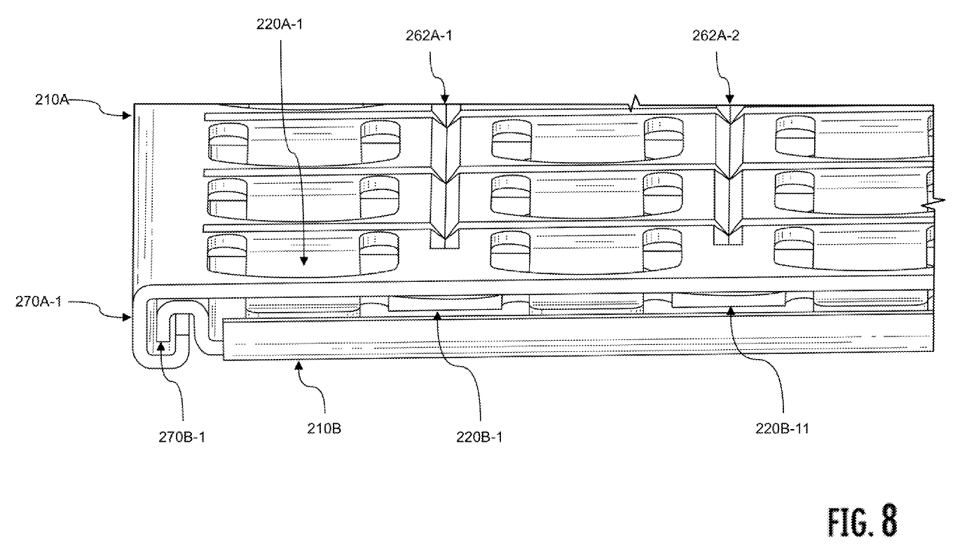

FIG. 8 is a detail perspective view of the compression pad of FIG. 2 defined by detail circle B in accordance with various example embodiments of the present disclosure. The illustrated view depicts a detailed portion of the interleaved arrangement between the first multi-spring compression plate 210A and the second multi-spring compression plate 210B that together form a compression pad 200.

The first multi-spring compression plate 210A includes the first spring 220A-1’ extending from the first multi-spring compression plate 210A toward the second multi-spring compression plate 210B. The first multi-spring compression plate 210A further includes the first elongate stiffening rib 262A-1 positioned within a support region between adjacent springs of the first multi-spring compression plate 210A. The first elongate stiffening rib 262A-1 provides a contact surface configured to receive springs from the second multi-spring compression plate 210B during compression.

The second multi-spring compression plate 210B includes the first spring 220B-1’ and the eleventh spring 220B-11’ extending from the second multi-spring compression plate 210B toward the first multi-spring compression plate 210A. The second multi-spring compression plate 210B includes the first rail 270B-1 positioned along an edge of the second multi-spring compression plate 210B. The rail 270A-1 and rail 270B-1 structures facilitate coupling between the first multi-spring compression plate 210A and the second multi-spring compression plate 210B while permitting relative displacement along a compression axis.

The first multi-spring compression plate 210A and the second multi-spring compression plate 210B are configured as twin spring plates with interleaved springs. In this interleaved configuration, the first spring 220B-1 and the eleventh spring 220B-11 of the second multi-spring compression plate 210B are respectively positioned to engage with the first elongate stiffening rib 262A-1 and the second elongated stiffening rib 262A-2.

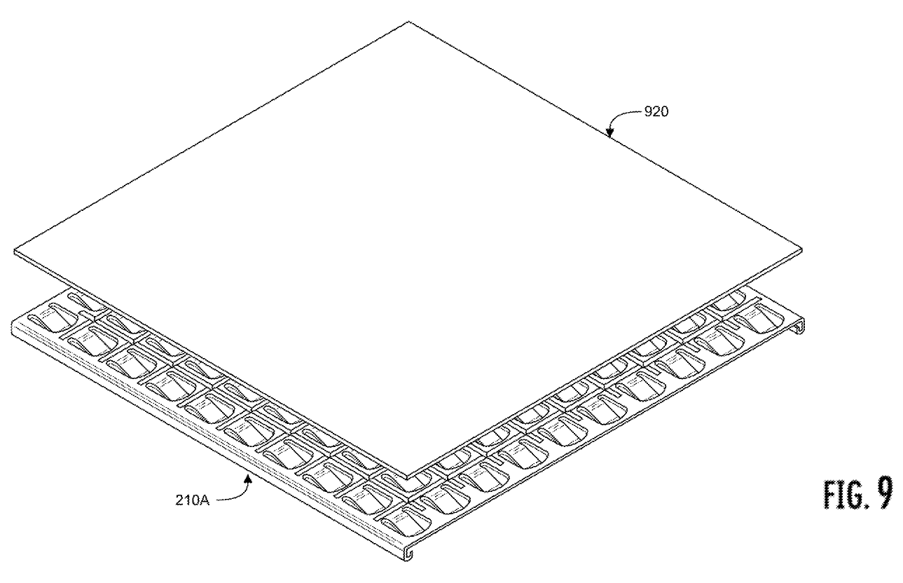

FIG. 9 is a perspective view of a multi-spring compression plate positioned proximate a heat transfer plate in accordance with various example embodiments of the present disclosure. The first multi-spring compression plate 210A comprises a compression plate body having a plurality springs. A heat transfer plate 920 may be bonded to the first multi-spring compression plate 210A, such as on a first side of the compression plate body. In various embodiments, the heat transfer plate 920 can be an Aluminum plate having a first thickness for thermal conductivity to distribute or disperse heat. In various embodiments, the heat transfer plate 920 may be bonded to the first multi-spring compression plate 210A. The bonding may be with, for example, thermally conductive adhesive or double-sided tape that facilitates heat transfer.

In various embodiments, the bonding of the heat transfer plate 920 to the first multi-spring compression plate 210A achieves enhanced structural stiffness. The combined stiffness can exceed the sum of the stiffness of the individual components. In various applications, the enhanced stiffness can reduce pressure concentrations acting on battery cells during compression, which can provide greater uniformity in pressure distribution across the battery cell surfaces during charging and discharging cycles.

In various embodiments, the heat transfer plate 920 may also distribute pressure across the surface of the compression pad. In various embodiments, the heat transfer plate 920, when bonded to the first multi-spring compression plate 210A, provides a continuous surface that spreads localized forces from the elongate spring bodies over a larger area. A pressure distribution function may reduce point loading on adjacent battery cell surfaces and promote more uniform contact between the compression pad and the battery cells during expansion and contraction cycles. In various embodiments, the heat transfer plate 920 may provide both for thermal management and pressure distribution simultaneously.

In various embodiments, the multi-spring compression plates (e.g., 210A) and the heat transfer plate 920 may be formed from materials having thermal and electrical conductivity properties. For example, the first multi-spring compression plate 210A and the second multi-spring compression plate of a compression pad may be formed from metallic materials that provide thermal conductivity to facilitate heat dissipation from adjacent battery cells. The heat transfer plate 920 may similarly be formed from thermally conductive materials, and when bonded to a multi-spring compression plate 210A, the combined assembly may provide an enhanced thermal pathway for conducting heat away from battery cell surfaces during charging and/or discharging operations. In some embodiments, the electrical conductivity of the multi-spring compression plates and the heat transfer plate 920 may provide either conductivity or electrical isolation within a battery module.

While a compression pad 200 may include a first multi-spring compression plate 210A positioned over an opposing second multi-spring compression plate along with a heat transfer plate 920, various embodiments include a compression pad of a single multi-spring compression plate 210A and a heat transfer plate 920.

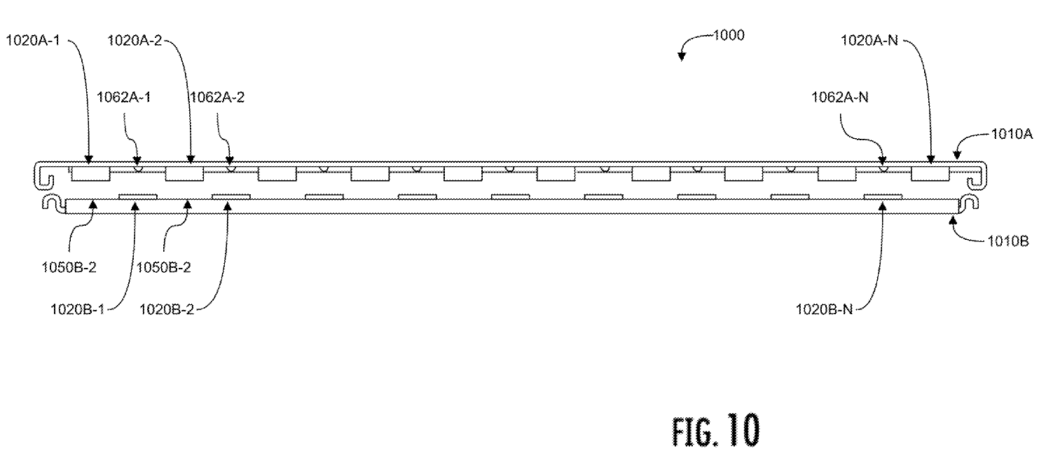

FIG. 10 is a side view of a pair of multi-spring compression plates of a compression pad in accordance with various example embodiments of the present disclosure. The illustrated view depicts a compression pad 1000 comprising a first multi-spring compression plate 1010A positioned in an opposing arrangement with a second multi-spring compression plate 1010B. The compression pad 1000 is configured with interleaved springs, wherein the springs from one multi-spring compression plate act on the support regions between the springs on the opposing multi-spring compression plate.

The first multi-spring compression plate 1010A includes a plurality of bridge springs1020A extending from the first multi-spring compression plate 1010A toward the second multi-spring compression plate 1010B. The first multi-spring compression plate 1010A further includes elongate stiffening ribs 1062A, including a first elongate stiffening rib 1062A-1, a second elongate stiffening rib 1062A-2, and an nth elongate stiffening rib 1062A-N positioned within support regions between adjacent springs of the first multi-spring compression plate 1010A. The first elongate stiffening rib 1062A-1, the second elongate stiffening rib 1062A-2, and the nth elongate stiffening rib 1062A-N provide contact surfaces configured to receive springs from the second multi-spring compression plate 1010B during compression.

The second multi-spring compression plate 1010B includes a first spring 1020B-1, a second spring 1020B-2, and an nth spring 1020B-N extending from the second multi-spring compression plate 1010B toward the first multi-spring compression plate 1010A. Each of the first spring 1020B-1, the second spring 1020B-2, and the nth spring 1020B-N comprises an elongate spring body 130 configured to engage with the elongate stiffening ribs 1062A of the first multi-spring compression plate 1010A. The second multi-spring compression plate 1010B includes a support regions, including a first support region 1050B-1 and second support region 1050B-2 defined between respective adjacent pairs of springs 1020B.

In various embodiments, the second multi-spring compression plate 1010B may or may not include elongate stiffening ribs within the support regions 1050B. For example, the first multi-spring compression plate 1010A can include a first spring 1020A-1, a second spring 1020A-2, and an nth spring 1020A-N of bridge springs that extend toward the second multi-spring compression plate 1010B. The bridge springs of the first multi-spring compression plate 1010A are positioned to act on the support regions 1050B of the second multi-spring compression plate 1010B, including without elongate stiffening ribs in those support regions 1050B.

The interleaved configuration of the compression pad 1000 demonstrates the first spring 1020B-1, the second spring 1020B-2, and the nth spring 1020B-N of the second multi-spring compression plate 1010B are positioned to engage with the first elongate stiffening rib 1062A-1, the second elongate stiffening rib 1062A-2, and the nth elongate stiffening rib 1062A-N of the first multi-spring compression plate 1010A.

Various embodiments of a compression pad 200 may include multiple multi-spring compression plates (e.g., 110’, 110’’, 110’’’, 210A, 210B). While some embodiments including two multi-spring compression plates (e.g., 210A, 210B) are illustrated, it will be appreciated that a compression pad 200 may include more than two multi-spring compression plates, such as three, four, five, etc. multi-spring compression plates. It will also be appreciated that a compression pad 200 may include only one multi-spring compression plate.

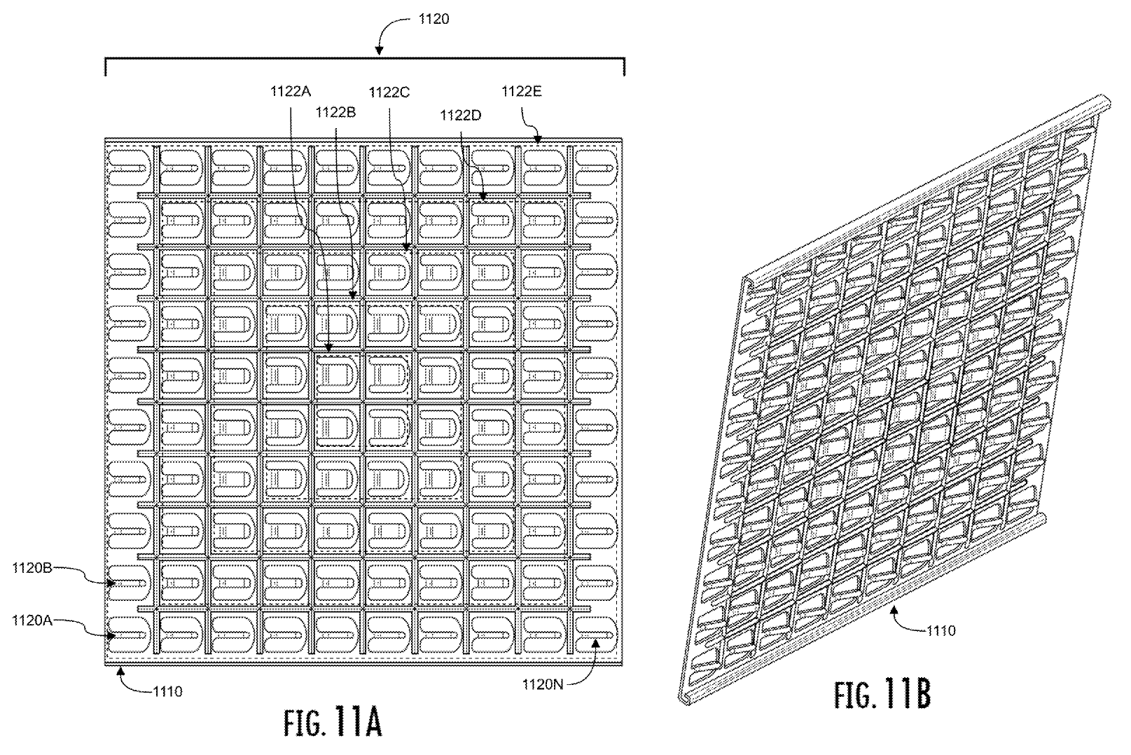

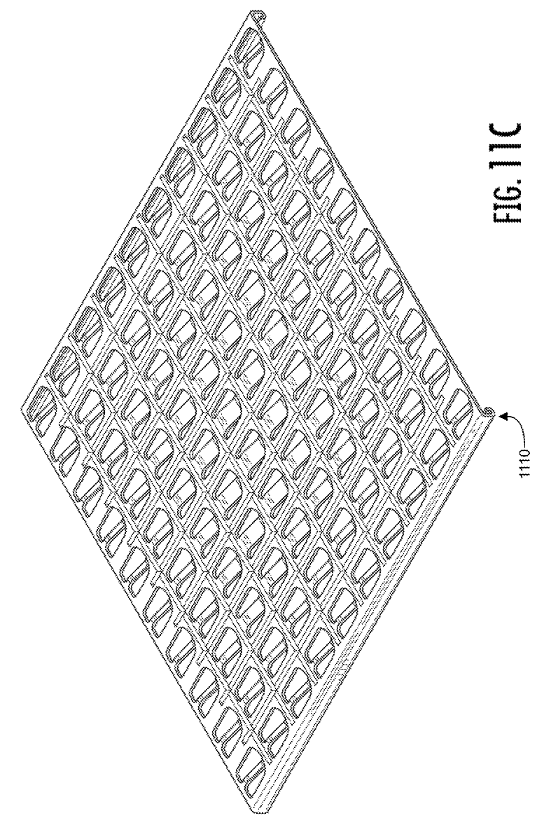

FIG. 11A is a top view of a multi-spring compression plate structured to define differential width spring designs in accordance with various example embodiments of the present disclosure. For ease of reference, when referring collectively to a plurality of springs distributed over the surface of the compression plate 1110, the present disclosure uses the element label 1120 to refer to such respective collections of springs, such as illustrated with a bracket that may be used to refer to the plurality of springs of FIG. 11A. The multi-spring compression plate 1110 comprises a compression plate body 112 having a plurality of springs 1120 (e.g., 1120A, 1120B, ... 1120N) arranged in a grid pattern across the multi-spring compression plate 1110. The multi-spring compression plate 1110 illustrates an embodiment featuring different springs designs. In the illustrated embodiments, there are differential width spring designs configured to provide a compression pad 200 with a tunable pressure distribution solution.

In various embodiments, the elongated spring body of each of the springs 1120 of the multi-spring compression plate 1110 may have a same length, a same or similar shape, one or more of the same compression angles, and have a width that differs from other springs 1120 of the multi-spring compression plate 1110. In various embodiments, one or more of the springs 1120 may be varied from one or more other springs 1120, such as by having one or more of a different material grade, material thickness, spring width, spring height, compression angle(s), surface size, etc.

In various embodiments, the multi-spring compression plate 1110 includes a first plurality of springs 1122A, a second plurality of springs 1122B, a third plurality of springs 1122C, a fourth plurality of springs 1122D, and a fifth plurality of springs 1122E arranged in a nested configuration across the compression plate body. The first plurality of springs 1122A is positioned in a central region of the multi-spring compression plate 1110 and comprises springs having the largest physical structure with the largest width. The second plurality of springs 1122B surrounds the first plurality of springs 1122A and comprises springs having a width smaller than the first plurality of springs 1122A. The third plurality of springs 1122C surrounds the second plurality of springs 1122B and comprises springs having a width smaller than the second plurality of springs 1122B. The fourth plurality of springs 1122D surrounds the third plurality of springs 1122C and comprises springs having a width smaller than the third plurality of springs 1122C. The fifth plurality of springs 1122E is positioned at the outermost portion of the multi-spring compression plate 1110 and comprises springs having the smallest width, including the nth spring 1120N.

The differential pressure provided by a compression pad from across the different plurality of springs 1120 of the multi-spring compression plate 1110 may be uniform, despite sharing the same material, thickness, and spring form, the springs may have different widths thereby providing differential spring pressures while maintaining similar shapes and placements across the multi-spring compression plate 1110. Additionally or alternatively, in various embodiments a multi-spring compression plate 1110 may be varied in stiffness, such as from corner-to-corner (e.g., stiff top right, soft bottom left, and gradient in between), from side to side (e.g., top to bottom, left to right), in a pattern, or from center to exterior. Such varying spring stiffness arrangements within multi-spring compression plates may be selected or designed based on the dimensional variation expected to occur for a particular battery cell system during its charge/discharge cycles or during its useful life.

In various embodiments, the nested arrangement of the first plurality of springs 1122A, the second plurality of springs 1122B, the third plurality of springs 1122C, the fourth plurality of springs 1122D, and the fifth plurality of springs 1122E provides for a compression pad configuration with uniform spring constant across the compression pad as a whole while the different springs 1120 may have different spring constants than other springs 1120 of the multi-spring compression plate 1110. The innermost springs of the first plurality of springs 1122A are surrounded by the most adjacent springs, while the outermost springs of the fifth plurality of springs 1122E do not include any further springs outside of them. The differential width of various of the springs 1120 provides for a compression pad to have uniform distribution of compression reaction force across the entire surface of the compression pad 200 when compression occurs.

FIG. 11B is a first perspective view of the multi-spring compression plate of FIG. 11A in accordance with various example embodiments of the present disclosure. The multi-spring compression plate 1110 comprises a compression plate body having a plurality of springs 1120 arranged in a grid pattern across the surface of the multi-spring compression plate 1110. The perspective view illustrates the three-dimensional configuration of the springs 1120 extending from the compression plate body, allowing for visualization of the differential width spring designs configured to provide a tunable pressure distribution solution.

The perspective view of FIG. 11B allows for seeing the differences in springs from this viewing angle, illustrating how the nested arrangement of the first plurality of springs, the second plurality of springs, the third plurality of springs, the fourth plurality of springs, and the fifth plurality of springs provides for a compression pad configuration with differential spring rates. The differential width of the springs provides for uniform distribution of compression reaction force across the entire surface of the compression pad when compression occurs, with more powerful springs positioned around the center and weaker springs positioned around the periphery.

FIG. 11C is a second perspective view of the multi-spring compression plate of FIG. 11A in accordance with various example embodiments of the present disclosure. The perspective view illustrates the multi-spring compression plate 1110 from an alternative viewing angle that allows for visualization of the three-dimensional configuration of the springs extending from the compression plate body.

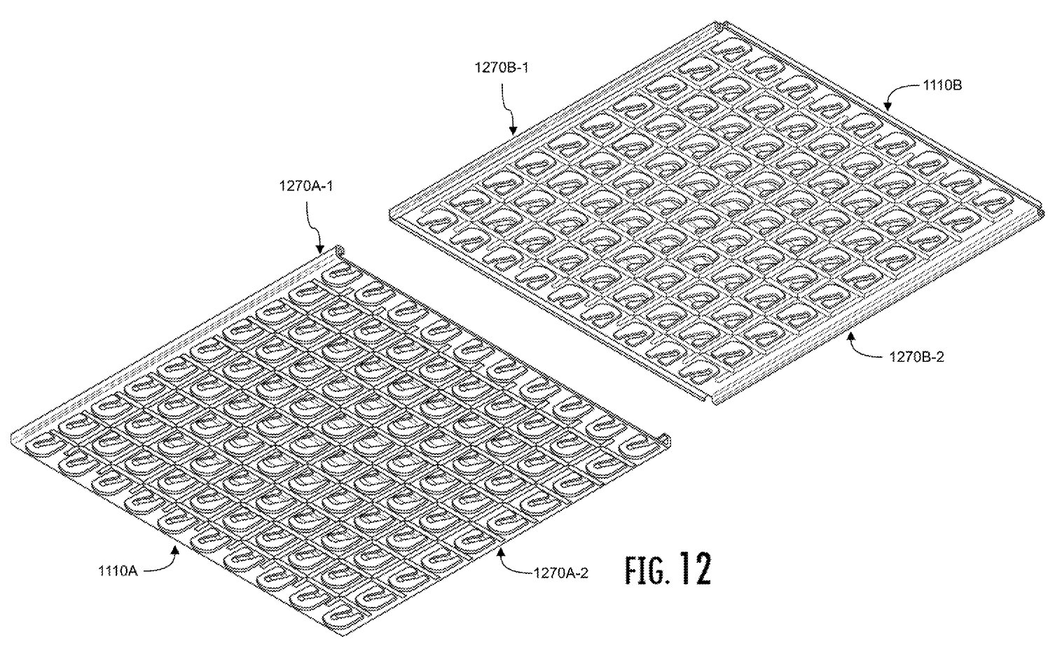

FIG. 12 is a perspective view of a pair of multi-spring compression plates structured to define differential width spring designs in accordance with various example embodiments of the present disclosure. The illustrated view depicts a first multi-spring compression plate 1110A and a second multi-spring compression plate 1110B that may form a compression pad. The first multi-spring compression plate 1110A and the second multi-spring compression plate 1110B are configured as twin spring plates with interleaved springs, wherein the springs from one multi-spring compression plate act on the support regions between the springs on the opposing multi-spring compression plate.

The first multi-spring compression plate 1110A includes a first rail 1270A-1 positioned along a first edge of the first multi-spring compression plate 1110A and a second rail 1270A-2 positioned along an opposing second edge of the first multi-spring compression plate 1110A. The second multi-spring compression plate 1110B includes a first rail 1270B-1 positioned along a first edge of the second multi-spring compression plate 1110B and a second rail 1270B-2 positioned along an opposing second edge of the second multi-spring compression plate 1110B. The first rail 1270A-1 is configured to engage with the first rail 1270B-1, and the second rail 1270A-2 is configured to engage with the second rail 1270B-2 to couple the first multi-spring compression plate 1110A and the second multi-spring compression plate 1110B together while permitting relative displacement along a compression axis.

The first multi-spring compression plate 1110A and the second multi-spring compression plate 1110B each comprise a compression plate body having a plurality of springs arranged in a grid pattern across the respective surfaces. In various embodiments, the first multi-spring compression plate 1110A and the second multi-spring compression plate 1110B may include differential width spring designs as described with respect to the multi-spring compression plate 1110 of FIGS. 11A-11C. The rail structures of the first rail 1270A-1, the second rail 1270A-2, the first rail 1270B-1, and the second rail 1270B-2 facilitate controlled assembly of the first multi-spring compression plate 1110A and the second multi-spring compression plate 1110B into a compression pad.

While FIGS. 11A-11C and 12 illustrate various embodiments of multi-spring compression plates (e.g., 1110, 1210) structured to define differential width spring designs in accordance with various example embodiments of the present disclosure, it will also be appreciated that there are additional embodiments of multi-spring compression plates with differential width spring designs. For example, in some embodiments, elongate spring bodies may define larger widths of springs positioned in a central region of a multi-spring compression plate to provide higher spring constants in such central region. Elongate spring bodies formed outside of the central region, such as in peripheral regions, may define smaller widths thereby providing lower spring constants in these regions. In some embodiments, a battery cell may “breathe” during charging and/or discharging, which may cause the battery cell to have a convex shape while “breathing,” and a central region of a multi-spring compression plate may thus be structured to have higher spring constants in such central region as compared to peripheral regions of the multi-spring compression plate.

FIG. 13 is a perspective view of a first embodiment of a spring structured for use in a multi-spring compression plate in accordance with various example embodiments of the present disclosure. In various embodiments, the spring 1300 may be referred to as finger wave spring or a finger wave. The illustrated view depicts a spring 1300 comprising an elongate spring body 1330 that has a spring shaping aperture 1340 defined by an aperture perimeter 1342. The spring 1300 includes a spring connection 1324 that provides an attachment interface between the elongate spring body 1330 and a compression plate body. The elongate spring body 1330 extends from the spring connection 1324 and defines a first spring compression angle 1322A and a second spring compression angle 1322B relative to the spring connection 1324. The first spring compression angle 1322A and the second spring compression angle 1322B are structured to define the compressive engagement characteristics of the spring 1300 when the spring 1300 engages with a reciprocally aligned elongate stiffening rib or elongate stiffening cross-rib of an opposing multi-spring compression plate. The spring 1300 further includes a spring contact surface 1326 positioned at a distal end of the elongate spring body 1330, wherein the spring contact surface 1326 is configured to engage with the elongate stiffening rib or elongate stiffening cross-rib of the opposing multi-spring compression plate during compression. In various embodiments, the spring contact surface 1326 may be configured as a flat plateau shape. The spring contact surface 1326 is an elongate stiffening rib-engagement surface that is configured to slideably engage the reciprocally aligned elongate stiffening rib or elongate stiffening cross-rib of an opposing multi-spring compression plate. The spring shaping aperture 1340 has a u-shaped configuration defined by the aperture perimeter 1342, which includes a concave aperture perimeter portion. The geometry of the first spring compression angle 1322A and the second spring compression angle 1322B, in combination with the configuration of the elongate spring body 1330, provides a first spring constant associated with this geometry that determines the compressive force characteristics of the spring 1300 during operation within a compression pad.

FIG. 14 is a perspective view of a second embodiment of a spring structured for use in a multi-spring compression plate in accordance with various example embodiments of the present disclosure. In various embodiments, the spring 1400 may be referred to as finger wave spring or a finger wave. The illustrated view depicts a spring 1400 comprising an elongate spring body 1430 that has a spring shaping aperture 1440 defined by an aperture perimeter 1442, which includes a concave aperture perimeter portion. The spring 1400 includes a spring connection 1424 that provides an attachment interface between the elongate spring body 1430 and a compression plate body. The elongate spring body 1430 extends from the spring connection 1424 and defines a first spring compression angle 1422A and a second spring compression angle 1422B relative to the spring connection 1424. The first spring compression angle 1422A and the second spring compression angle 1422B of the spring 1400 are configured with steeper angles compared to the first spring compression angle 1322A and the second spring compression angle 1322B of the spring 1300 illustrated in FIG. 13. The steeper configuration of the first spring compression angle 1422A and the second spring compression angle 1422B is structured to define different compressive engagement characteristics when the spring 1400 engages with a reciprocally aligned elongate stiffening rib or elongate stiffening cross-rib of an opposing multi-spring compression plate. The spring 1400 further includes a spring contact surface 1426 positioned at a distal end of the elongate spring body 1430, wherein the spring contact surface 1426 is configured to engage with the elongate stiffening rib or elongate stiffening cross-rib of the opposing multi-spring compression plate during compression. This spring contact surface 1426 is an elongate stiffening rib-engagement surface. In various embodiments, the spring contact surface 1426 may be configured as a flat plateau shape. The spring shaping aperture 1440 has a u-shaped configuration defined by the aperture perimeter 1442. The geometry of the first spring compression angle 1422A and the second spring compression angle 1422B, in combination with the configuration of the elongate spring body 1430, provides a second spring constant associated with this geometry that differs from the first spring constant of the spring 1300 of FIG. 13, thereby determining different compressive force characteristics of the spring 1400 during operation within a compression pad.

FIG. 15 is a perspective view of a third embodiment of a spring structured for use in a multi-spring compression plate in accordance with various example embodiments of the present disclosure. In various embodiments, the spring 1500 may be referred to as finger wave spring or a finger wave. The illustrated view depicts a spring 1500 comprising an elongate spring body 1530 that has a spring shaping aperture 1540 defined by an aperture perimeter 1542, which includes a concave aperture perimeter portion. The spring 1500 includes a spring connection 1524 that provides an attachment interface between the elongate spring body 1530 and a compression plate body. The elongate spring body 1530 extends from the spring connection 1524 and defines a first spring compression angle 1522A, a second spring compression angle 1522B, and a third spring compression angle 1522C relative to the spring connection 1524. The first spring compression angle 1522A, the second spring compression angle 1522B, and the third spring compression angle 1522C are structured to define the compressive engagement characteristics of the spring 1500 when the spring 1500 engages with a reciprocally aligned elongate stiffening rib or elongate stiffening cross-rib of an opposing multi-spring compression plate. The spring 1500 further includes a spring contact surface 1526 of the elongate spring body 1530, wherein the spring contact surface 1526 is configured to engage with the elongate stiffening rib or elongate stiffening cross-rib of the opposing multi-spring compression plate during compression. This spring contact surface 1526 is an elongate stiffening rib-engagement surface. In various embodiments, the spring contact surface 1526 may be configured as a flat plateau shape. The spring 1500 additionally includes a spring second contact surface 1550 positioned along the elongate spring body 1530 at a distal end. The spring second contact surface 1550 may contact a portion of a battery cell or a heat transfer plate in various embodiments, providing an additional contact interface and/or for thermal management or pressure distribution functions. The spring shaping aperture 1540 has a u-shaped configuration defined by the aperture perimeter 1542. The geometry of the first spring compression angle 1522A, the second spring compression angle 1522B, and the third spring compression angle 1522C, in combination with the configuration of the elongate spring body 1530 and the spring second contact surface 1550, provides a third spring constant associated with this geometry that determines the compressive force characteristics of the spring 1500 during operation within a compression pad.

FIG. 16 is a perspective view of a fourth embodiment of a spring structured for use in a multi-spring compression plate in accordance with various example embodiments of the present disclosure. In various embodiments, the spring 1600 may be referred to as finger wave spring or a finger wave. The illustrated view depicts a spring 1600 comprising an elongate spring body 1630 that has a spring shaping aperture 1640 defined by an aperture perimeter 1642, which includes a concave aperture perimeter portion. The spring 1600 includes a spring connection 1624 that provides an attachment interface between the elongate spring body 1630 and a compression plate body. The elongate spring body 1630 extends from the spring connection 1624 and defines a first spring compression angle 1622A, a second spring compression angle 1622B, and a third spring compression angle 1622C relative to the spring connection 1624. The first spring compression angle 1622A, the second spring compression angle 1622B, and the third spring compression angle 1622C are structured to define the compressive engagement characteristics of the spring 1600 when the spring 1600 engages with a reciprocally aligned elongate stiffening rib or elongate stiffening cross-rib of an opposing multi-spring compression plate. The spring 1600 further includes a spring contact surface 1626 positioned along the elongate spring body 1630, wherein the spring contact surface 1626 is configured to engage with the elongate stiffening rib or elongate stiffening cross-rib of the opposing multi-spring compression plate during compression. This spring contact surface 1626 is an elongate stiffening rib-engagement surface. In various embodiments, the spring contact surface 1626 may be configured as a flat plateau shape. The spring 1600 additionally includes a spring second contact surface 1650 positioned along the elongate spring body 1630 at a distal end. The spring second contact surface 1650 may contact a portion of a battery cell or a heat transfer plate in various embodiments, providing an additional contact interface for thermal management or pressure distribution functions. The spring shaping aperture 1640 has a u-shaped configuration defined by the aperture perimeter 1642. The geometry of the first spring compression angle 1622A, the second spring compression angle 1622B, and the third spring compression angle 1622C, in combination with the configuration of the elongate spring body 1630 and the spring second contact surface 1650, provides a fourth spring constant associated with this geometry that determines the compressive force characteristics of the spring 1600 during operation within a compression pad.

It will be appreciated that the illustrations of the springs 1300, 1400, 1500, and 1600 of FIGS. 13-16 are provided for illustrative purposes and that the specific spring geometries may not represent exact physical proportions. For example, an elongate spring body 1530 may be illustrated to be comparatively long relative to a respective spring shaping aperture 1540. This may be for illustrative purposes. For example, a distal end of the elongate spring body 1530 would not, when compressed, contact a far side of the spring second contact surface 1550.

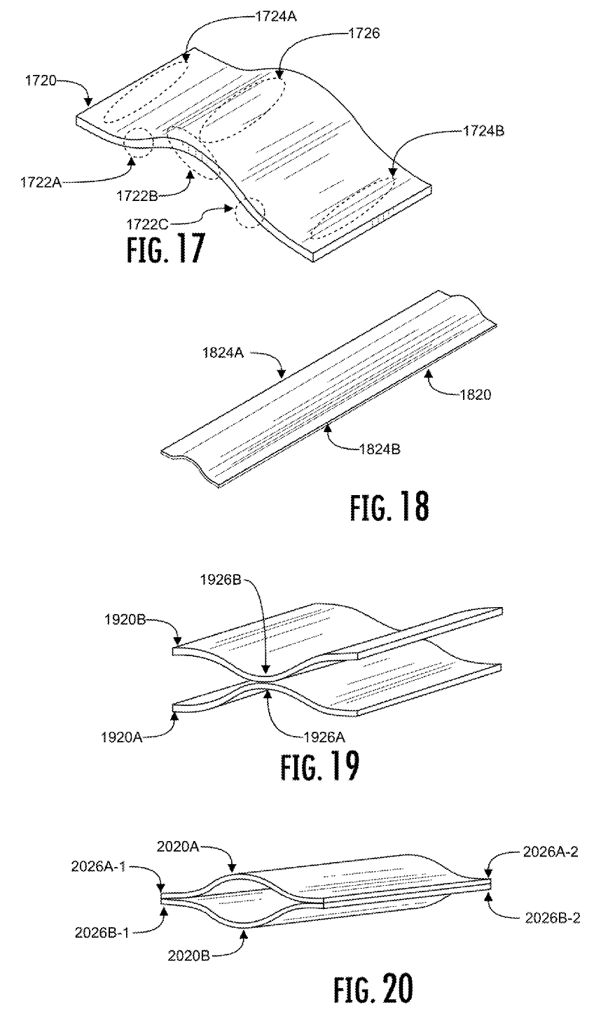

FIG. 17 is a perspective view of a fifth embodiment of a spring structured for use in a multi-spring compression plate in accordance with various example embodiments of the present disclosure. The illustrated view depicts a spring 1720 that may be configured as a bridge spring comprising an elongate spring body that extends between a first spring connection 1724A and a second spring connection 1724B. The first spring connection 1724A and the second spring connection 1724B can be where the spring 1720 connects to a multi-spring compression plate body. The spring 1720 is structured to provide compressive engagement within a compression pad configuration. In various embodiments, such as those later illustrated, the spring connections may be located in different areas of the spring 1720.

The spring 1720 includes a first spring connection 1724A positioned at a first end of the elongate spring body and a second spring connection 1724B positioned at a second end of the elongate spring body. The first spring connection 1724A and the second spring connection 1724B provide attachment interfaces between the spring 1720 and a compression plate body. The elongate spring body extends between the first spring connection 1724A and the second spring connection 1724B and defines a first spring compression angle 1722A, a second spring compression angle 1722B, and a third spring compression angle 1722C relative to the respective spring connections.

The first spring compression angle 1722A, the second spring compression angle 1722B, and the third spring compression angle 1722C are structured to define the compressive engagement characteristics of the spring 1720 when the spring 1720 engages with a reciprocally aligned elongate stiffening rib or elongate stiffening cross-rib of an opposing multi-spring compression plate. The spring 1720 further includes a first spring contact surface 1726 positioned along the elongate spring body, wherein the first spring contact surface 1726 is configured to engage with an elongate stiffening rib or elongate stiffening cross-rib of an opposing multi-spring compression plate during compression, or alternatively to engage with a corresponding spring contact surface of an opposing bridge spring. In various embodiments, the first spring contact surface 1726 may be configured as a flat plateau shape.

The bridge spring configuration of the spring 1720, with the first spring connection 1724A and the second spring connection 1724B at opposing ends, provides a spanning structure that distributes compressive forces across a wider area of the compression plate body compared to single-connection spring embodiments. The geometry of the first spring compression angle 1722A, the second spring compression angle 1722B, and the third spring compression angle 1722C, in combination with the configuration of the elongate spring body extending between the first spring connection 1724A and the second spring connection 1724B, provides a fifth spring constant associated with this geometry that determines the compressive force characteristics of the spring 1720 during operation within a compression pad. In various embodiments, the structure of spring 1720 may be configured as a finger wave spring with a connection of the spring 1720 at only one spring connection (e.g., 1724A or 1724B).

FIG. 18 is a perspective view of a sixth embodiment of a spring structured for use in a multi-spring compression plate in accordance with various example embodiments of the present disclosure. The illustrated view depicts a spring 1820 that may be configured as a bridge spring comprising an elongate spring body that extends between a first spring connection 1824A and a second spring connection 1824B. The first spring connection 1824A and the second spring connection 1824B provide attachment interfaces between the spring 1820 and a compression plate body, wherein the spring 1820 is structured to provide compressive engagement within a compression pad.

The spring 1820 includes the first spring connection 1824A positioned at a first end of the elongate spring body and the second spring connection 1824B positioned at a second end of the elongate spring body. The first spring connection 1824A and the second spring connection 1824B of the spring 1820 are configured with longer dimensions compared to the first spring connection 1724A and the second spring connection 1724B of the spring 1720 illustrated in FIG. 17. The elongated configuration of the first spring connection 1824A and the second spring connection 1824B provides for a different spring constant due to the different shape of the spring 1820 compared to the spring 1720 of FIG. 17.

The bridge spring configuration of the spring 1820, with the first spring connection 1824A and the second spring connection 1824B at opposing ends having longer dimensions than the corresponding connections of the spring 1720, provides a spanning structure that distributes compressive forces across a wider area of the compression plate body. The geometry of the first spring compression angle 1722A, the second spring compression angle 1722B, and the third spring compression angle 1722C, in combination with the elongated configuration of the first spring connection 1824A and the second spring connection 1824B, provides a sixth spring constant associated with this geometry that differs from the fifth spring constant of the spring 1720 of FIG. 17, thereby determining different compressive force characteristics of the spring 1820 during operation within a compression pad. In various embodiments, the structure of spring 1820 may be configured as a finger wave spring with a connection of the spring 1820 at only one spring connection (e.g., 1824A or 1824B).

FIG. 19 is a perspective view of a first pair of bridge springs structured for use in a compression pad in accordance with various example embodiments of the present disclosure. The illustrated view depicts a first spring 1920A positioned in an opposing arrangement with a second spring 1920B to form a paired bridge spring configuration. The first spring 1920A and the second spring 1920B are each configured as bridge springs, wherein the first spring 1920A may comprise a spring 1720 or a spring 1820, and the second spring 1920B may similarly comprise a spring 1720 or a spring 1820.

The first spring 1920A includes a first spring contact surface 1926A positioned along the elongate spring body of the first spring 1920A. The second spring 1920B includes a second spring contact surface 1926B positioned along the elongate spring body of the second spring 1920B. The first spring contact surface 1926A and the second spring contact surface 1926B are configured to engage one another when the first spring 1920A and the second spring 1920B are positioned in the opposing arrangement.

The pair of bridge springs illustrates the first spring 1920A contacting the second spring 1920B at the interface between the first spring contact surface 1926A and the second spring contact surface 1926B. This contact arrangement provides a single point of engagement between the opposing bridge springs 1920A and 1920B, wherein compressive forces applied to the paired configuration are transmitted through the first spring contact surface 1926A and the second spring contact surface 1926B. The geometry of the first spring 1920A and the second spring 1920B, in combination with the contact interface between the first spring contact surface 1926A and the second spring contact surface 1926B, provides compressive force characteristics suitable for use within a compression pad configuration.

FIG. 20 is a perspective view of a second pair of bridge springs structured for use in a compression pad in accordance with various example embodiments of the present disclosure. The illustrated view depicts a first spring 2020A positioned in an opposing arrangement with a second spring 2020B to form a paired bridge spring configuration with multiple contact points. The first spring 2020A and the second spring 2020B are each configured as bridge springs, wherein the first spring 2020A may comprise a spring 1720 or a spring 1820, and the second spring 2020B may similarly comprise a spring 1720 or a spring 1820.

The first spring 2020A includes a first spring first contact surface 2026A-1 and a first spring second contact surface 2026A-2 positioned along the elongate spring body of the first spring 2020A. The second spring 2020B includes a second spring first contact surface 2026B-1 and a second spring second contact surface 2026B-2 positioned along the elongate spring body of the second spring 2020B. The first spring first contact surface 2026A-1 and the second spring first contact surface 2026B-1 engage with one another when the first spring 2020A and the second spring 2020B are positioned in the opposing arrangement. Similarly, the first spring second contact surface 2026A-2 and the second spring second contact surface 2026B-2 engage with one another when the first spring 2020A and the second spring 2020B are positioned in the opposing arrangement. In various embodiments, the first contact surface 2026A-1, second contact surface 2026A-2, second spring first contact surface 2026B-1, and second spring second contact surface 2026B-2 may be configured as flat plateau shapes.

The pair of bridge springs illustrates the first spring 2020A contacting the second spring 2020B at two distinct interfaces. A first contact interface is formed between the first spring first contact surface 2026A-1 and the second spring first contact surface 2026B-1. A second contact interface is formed between the first spring second contact surface 2026A-2 and the second spring second contact surface 2026B-2. This dual contact arrangement provides two points of engagement between the opposing bridge springs, wherein compressive forces applied to the paired configuration are transmitted through both the first spring first contact surface 2026A-1 engaging the second spring first contact surface 2026B-1 and the first spring second contact surface 2026A-2 engaging the second spring second contact surface 2026B-2. The geometry of the first spring 2020A and the second spring 2020B, in combination with the dual contact interfaces, provides enhanced stability and distributed compressive force characteristics suitable for use within a compression pad configuration.

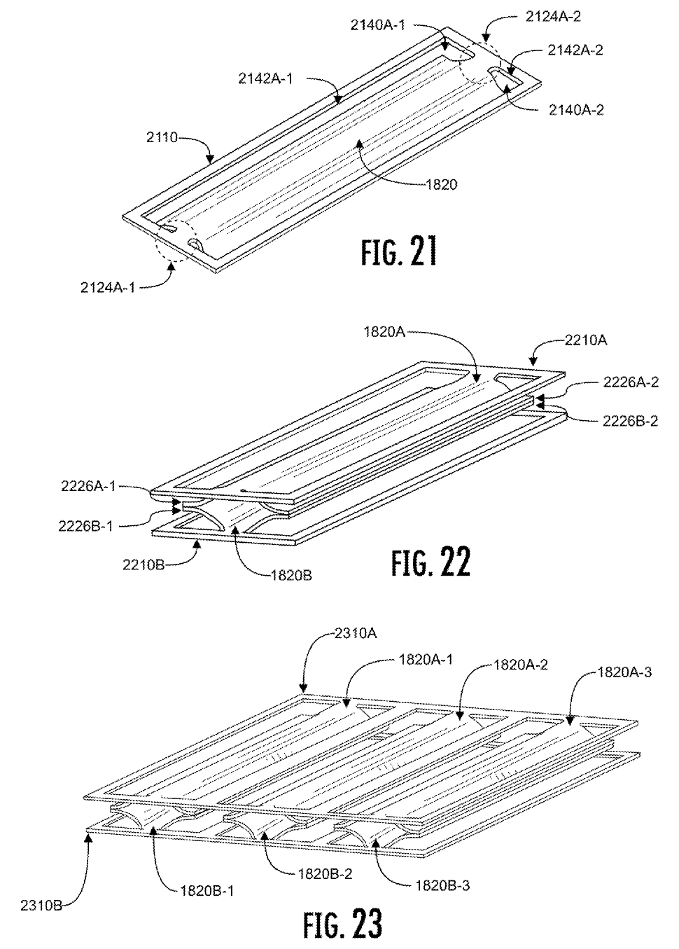

FIG. 21 is a perspective view of a seventh embodiment of a spring structured for use in a multi-spring compression plate in accordance with various example embodiments of the present disclosure. The illustrated view depicts a spring 1820 configured as a bridge spring connected to a multi-spring compression plate 2110 (though only one spring 1820 is illustrated). The spring 1820 comprises an elongate spring body that extends between a first spring connection 2124A-1 and a first spring connection 2124A-2, wherein the first spring connection 2124A-1 and the first spring connection 2124A-2 provides attachment interfaces between the spring 1820 and the multi-spring compression plate 2110.

The spring 1820 is defined by a first spring shaping aperture 2140A-1 and a second spring shaping aperture 2140A-2 extending through the multi-spring compression plate 2110. The first spring shaping aperture 2140A-1 has a u-shaped configuration defined by a first aperture perimeter 2142A-1. Similarly, the second spring shaping aperture 2140A-2 has a u-shaped configuration defined by a second aperture perimeter 2142A-2. In various embodiments, one or both of the first aperture perimeter 2142A-1 and the second aperture perimeter 2142A-2 may have concave aperture perimeter portions. The first spring shaping aperture 2140A-1 and the second spring shaping aperture 2140A-2 are positioned on opposing sides of the elongate spring body of the spring 1820, with each aperture having its own respective u-shaped configuration that defines the spring geometry.

The spring 1820 is connected to the multi-spring compression plate 2110 at short ends of the spring 1820 via the first spring connection 2124A-1 and the first spring connection 2124A-2. This bridge spring configuration, with connections at opposing ends, provides a spanning structure that distributes compressive forces across a wider area of the multi-spring compression plate 2110 compared to single-connection spring embodiments. In various embodiments, the spring 1820 may alternatively comprise a spring 1720 having similar bridge spring characteristics. The geometry of the spring 1820, in combination with the configuration of the first spring shaping aperture 2140A-1 and the second spring shaping aperture 2140A-2, provides compressive force characteristics suitable for use within a compression pad configuration.

FIG. 22 is a perspective view of a third pair of springs structured for use in a compression pad in accordance with various example embodiments of the present disclosure. The illustrated view depicts a first multi-spring compression plate 2210A positioned in an opposing arrangement with a second multi-spring compression plate 2210B to form a paired bridge spring configuration. The first multi-spring compression plate 2210A includes a first spring 1820A-1 configured as a bridge spring extending from the first multi-spring compression plate 2210A toward the second multi-spring compression plate 2210B. The second multi-spring compression plate 2210B includes a first spring 1820B-1 configured as a bridge spring extending from the second multi-spring compression plate 2210B toward the first multi-spring compression plate 2210A.

The first spring 1820A-1 of the first multi-spring compression plate 2310A includes a first spring contact surface 2226A-1 positioned along the elongate spring body of the first spring 1820A-1. The first spring 1820B-1 of the second multi-spring compression plate 2310B includes a first spring contact surface 2226B-1 positioned along the elongate spring body of the first spring 1820B-1. The first spring contact surface 2226A-1 and the first spring contact surface 2226B-1 are configured to engage one another when the first multi-spring compression plate 2210A and the second multi-spring compression plate 2210B are positioned in the opposing arrangement.

The pair of bridge springs illustrates the first spring 1820A-1 of the first multi-spring compression plate 2310A contacting the first spring 1820B-1 of the second multi-spring compression plate 2310B at the interface between the first spring contact surface 2226A-1 and the first spring contact surface 2226B-1. This contact arrangement provides a point of engagement between the opposing bridge springs, wherein compressive forces applied to the paired configuration are transmitted through the first spring contact surface 2226A-1 and the first spring contact surface 2226B-1. The geometry of the first spring 1820A-1 and the first spring 1820B-1, in combination with the contact interface between the first spring contact surface 2226A-1 and the first spring contact surface 2226B-1, provides compressive force characteristics suitable for use within a compression pad.

FIG. 23 is a perspective view of three pairs of springs structured for use in a compression pad in accordance with various example embodiments of the present disclosure. The illustrated view depicts a first multi-spring compression plate 2310A positioned in an opposing arrangement with a second multi-spring compression plate 2310B to form a compression pad configuration with multiple paired bridge springs.

The first multi-spring compression plate 2310A includes a first spring 1820A-1, a second spring 1820A-2, and a third spring 1820A-3 configured as bridge springs extending from the first multi-spring compression plate 2310A toward the second multi-spring compression plate 2310B. The second multi-spring compression plate 2310B includes a first spring 1820B-1, a second spring 1820B-2, and a third spring 1820B-3 configured as bridge springs extending from the second multi-spring compression plate 2310B toward the first multi-spring compression plate 2310A.

Each of the first spring 1820A-1, the second spring 1820A-2, and the third spring 1820A-3 of the first multi-spring compression plate 2310A includes respective spring contact surfaces configured to engage with corresponding spring contact surfaces of the first spring 1820B-1, the second spring 1820B-2, and the third spring 1820B-3 of the second multi-spring compression plate 2310B. The first spring 1820A-1 includes a first spring contact surface 2226A-1 positioned along the elongate spring body of the first spring 1820A-1, and the first spring 1820B-1 includes a first spring contact surface 2226B-1 positioned along the elongate spring body of the first spring 1820B-1. The first spring contact surface 2226A-1 and the first spring contact surface 2226B-1 are configured to engage one another when the first multi-spring compression plate 2310A and the second multi-spring compression plate 2310B are positioned in the opposing arrangement.

The three pairs of bridge springs illustrate how multiple bridge spring pairs can be arranged across the first multi-spring compression plate 2310A and the second multi-spring compression plate 2310B to provide distributed compressive engagement across the compression pad configuration. The geometry of the first spring 1820A-1, the second spring 1820A-2, the third spring 1820A-3, the first spring 1820B-1, the second spring 1820B-2, and the third spring 1820B-3, in combination with the contact interfaces between the respective spring contact surfaces, provides compressive force characteristics suitable for uniform pressure distribution within a compression pad.

FIG. 24 is a perspective view of an eighth embodiment of a spring structured for use in a multi-spring compression plate in accordance with various example embodiments of the present disclosure. The illustrated view depicts a spring 1820 configured as a finger wave spring connected to a multi-spring compression plate 2410, wherein the spring 1820 is attached along only one edge of the spring 1820 via a spring connection 2424. The spring 1820 comprises an elongate spring body that extends from the spring connection 2424, wherein the spring connection 2424 provides an attachment interface between the spring 1820 and a multi-spring compression plate 2410. The spring 1820 includes a spring contact surface 1826A positioned along the elongate spring body of the spring 1820, wherein the spring contact surface 1826A is configured to engage with a corresponding spring contact surface of an opposing spring or with an elongate stiffening rib of an opposing multi-spring compression plate during compression. The spring 1820 is defined by a spring shaping aperture 2440 extending through the compression plate 2410, wherein the spring shaping aperture 2440 has a u-shaped configuration defined by an aperture perimeter 2442. The single-edge connection configuration of the spring 1820 via the spring connection 2424 to the multi-spring compression plate 2410 provides a spring structure that differs from the dual-connection bridge spring configurations illustrated in previous embodiments.

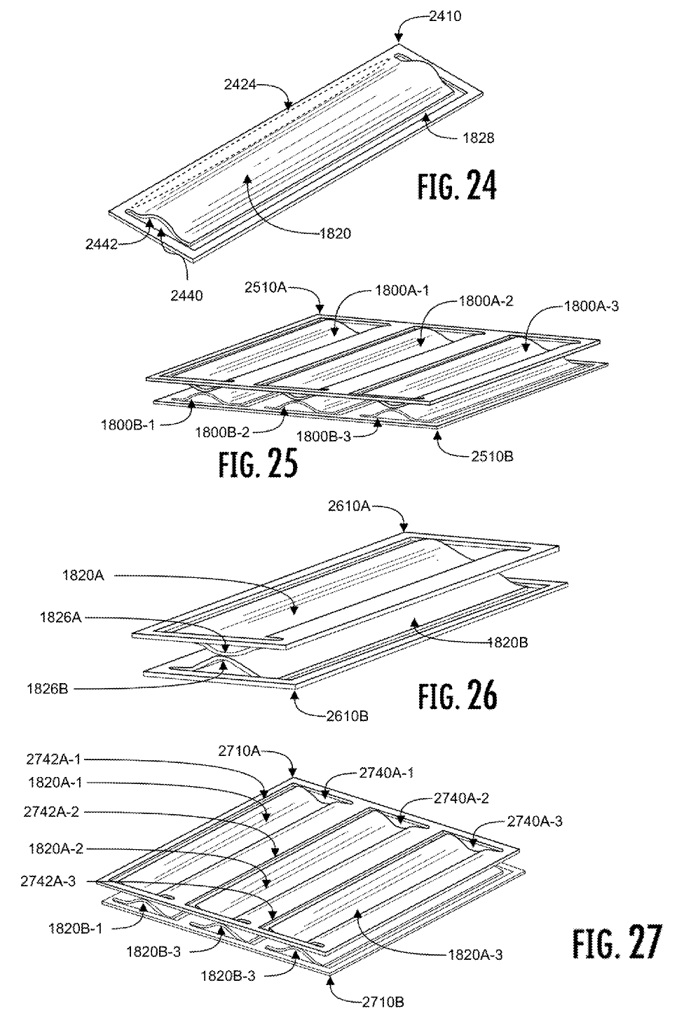

FIG. 25 is a perspective view of three pairs of springs structured for use in a compression pad in accordance with various example embodiments of the present disclosure. The illustrated view depicts a first multi-spring compression plate 2510A positioned in an opposing arrangement with a second multi-spring compression plate 2510B to form a compression pad configuration with multiple paired finger wave springs. It will be appreciated a compression pad may include more springs than illustrated.

The first compression plate 2510A includes a first spring 1800A-1, a second spring 1800A-2, and a third spring 1800A-3 configured as finger wave springs extending from the first compression plate 2510A toward the second compression plate 2510B. Each of the first spring 1800A-1, the second spring 1800A-2, and the third spring 1800A-3 comprises an elongate spring body that is connected to the first compression plate 2510A along one edge via a spring connection 2424. The first spring 1800A-1, the second spring 1800A-2, and the third spring 1800A-3 each include a spring contact surface 1826A positioned along the respective elongate spring body.

The second compression plate 2510B includes a first spring 1800B-1, a second spring 1800B-2, and a third spring 1800B-3 configured as finger wave springs extending from the second compression plate 2510B toward the first compression plate 2510A. Each of the first spring 1800B-1, the second spring 1800B-2, and the third spring 1800B-3 comprises an elongate spring body that is connected to the second compression plate 2510B along one edge via a spring connection 2424. The first spring 1800B-1, the second spring 1800B-2, and the third spring 1800B-3 each include a spring contact surface 1826B positioned along the respective elongate spring body.

Each of the first spring 1800A-1, the second spring 1800A-2, and the third spring 1800A-3 of the first compression plate 2510A is defined by a spring shaping aperture extending through the first multi-spring compression plate 2510A, wherein the spring shaping aperture has a u-shaped configuration defined by an aperture perimeter. Similarly, each of the first spring 1800B-1, the second spring 1800B-2, and the third spring 1800B-3 of the second multi-spring compression plate 2510B is defined by a spring shaping aperture extending through the second compression plate 2510B.

The spring contact surface 1826A of the first spring 1800A-1 is configured to engage with the spring contact surface 1826B of the first spring 1800B-1 when the first compression plate 2510A and the second compression plate 2510B are positioned in the opposing arrangement. Similarly, the spring contact surface 1826A of the second spring 1800A-2 engages with the spring contact surface 1826B of the second spring 1800B-2, and the spring contact surface 1826A of the third spring 1800A-3 engages with the spring contact surface 1826B of the third spring 1800B-3.

FIG. 26 is a perspective view of a pair of springs structured for use in a compression pad in accordance with various example embodiments of the present disclosure. The illustrated view depicts a first spring 1800A-1 positioned in an opposing arrangement with a first spring 1800B-1 to form a paired finger wave spring configuration. The first spring 1800A-1 and the first spring 1800B-1 are each configured as finger wave springs extending from respective compression plates, wherein each spring comprises an elongate spring body that is connected to its respective compression plate along one edge via a spring connection 2424. The first spring 1800A-1 extends from a first compression plate 2510A toward a second compression plate 2510B. The first spring 1800A-1 includes a spring contact surface 1826A positioned along the elongate spring body of the first spring 1800A-1. The first spring 1800B-1 extends from the second compression plate 2510B toward the first compression plate 2510A. The first spring 1800B-1 includes a spring contact surface 1826B positioned along the elongate spring body of the first spring 1800B-1. The spring contact surface 1826A of the first spring 1800A-1 is configured to engage with the spring contact surface 1826B of the first spring 1800B-1 when the first compression plate 2510A and the second compression plate 2510B are positioned in the opposing arrangement. This contact arrangement provides a point of engagement between the opposing finger wave springs, wherein compressive forces applied to the paired configuration are transmitted through the spring contact surface 1826A and the spring contact surface 1826B.

FIG. 27 is a perspective view of three pairs of springs structured for use in a compression pad in accordance with various example embodiments of the present disclosure. The illustrated view depicts a first multi-spring compression plate 2710A positioned in an opposing arrangement with a second multi-spring compression plate 2710B to form a compression pad configuration with multiple paired finger wave springs.

The first multi-spring compression plate 2710A includes a first spring 1820A-1, a second spring 1820A-2, and a third spring 1820A-3 configured as finger wave springs extending from the first multi-spring compression plate 2710A toward the second multi-spring compression plate 2710B. Each of the first spring 1820A-1, the second spring 1820A-2, and the third spring 1820A-3 comprises an elongate spring body that is connected to the first multi-spring compression plate 2710A along one edge via a spring connection 2424. The first spring 1820A-1, the second spring 1820A-2, and the third spring 1820A-3 each include a spring contact surface 1826A positioned along the respective elongate spring body.

The second multi-spring compression plate 2710B includes a first spring 1820B-1, a second spring 1820B-2, and a third spring 1820B-3 configured as finger wave springs extending from the second multi-spring compression plate 2710B toward the first multi-spring compression plate 2710A. Each of the first spring 1820B-1, the second spring 1820B-2, and the third spring 1820B-3 comprises an elongate spring body that is connected to the second multi-spring compression plate 2710B along one edge via a spring connection 2424. The first spring 1820B-1, the second spring 1820B-2, and the third spring 1820B-3 each include a spring contact surface 1826B positioned along the respective elongate spring body.

The illustrated view further depicts the u-shaped spring shaping apertures extending through the first multi-spring compression plate 2710A and the second multi-spring compression plate 2710B. The first multi-spring compression plate 2710A includes a spring shaping aperture 2740A-1 defined by an aperture perimeter 2742A-1, a spring shaping aperture 2740A-2 defined by an aperture perimeter 2742A-2, and a spring shaping aperture 2740A-3 defined by an aperture perimeter 2742A-3. Each of the spring shaping aperture 2740A-1, the spring shaping aperture 2740A-2, and the spring shaping aperture 2740A-3 has a u-shaped configuration that defines the geometry of the respective first spring 1820A-1, second spring 1820A-2, and third spring 1820A-3.

The spring contact surface 1826A of the first spring 1820A-1 is configured to engage with the spring contact surface 1826B of the first spring 1820B-1 when the first multi-spring compression plate 2710A and the second multi-spring compression plate 2710B are positioned in the opposing arrangement. Similarly, the spring contact surface 1826A of the second spring 1820A-2 engages with the spring contact surface 1826B of the second spring 1820B-2, and the spring contact surface 1826A of the third spring 1820A-3 engages with the spring contact surface 1826B of the third spring 1820B-3.

In various embodiments, the contact between one or more finger wave springs of a first compression plate 2710A may not be with an opposing finger wave spring but rather with one or more stiffening ribs (not illustrated). This may provide for contact for the full length of one or more stiffening ribs. For example, the first multi-spring compression plate 2710A and the second multi-spring compression plate 2710B may be positioned in a shifted or offset arrangement wherein the springs 1820A of the first multi-spring compression plate 2710A are offset by a wavelength relative to the springs of the opposing the second multi-spring compression plate 2710B. In this shifted configuration, the spring contact surfaces 1826A of the first multi-spring compression plate 2710A may engage with one or more elongate stiffening ribs of the second multi-spring compression plate 2710B rather than with the spring contact surfaces 1826B of opposing springs. Similarly, the spring contact surfaces 1826B of the second multi-spring compression plate 2710B may engage with the elongate stiffening ribs of the first multi-spring compression plate 2710A. Additionally or alternatively, in various embodiments, the contact of a finger wave spring 1820 may be with a surface of an opposing multi-spring compression plate (and not with a stiffening rib).

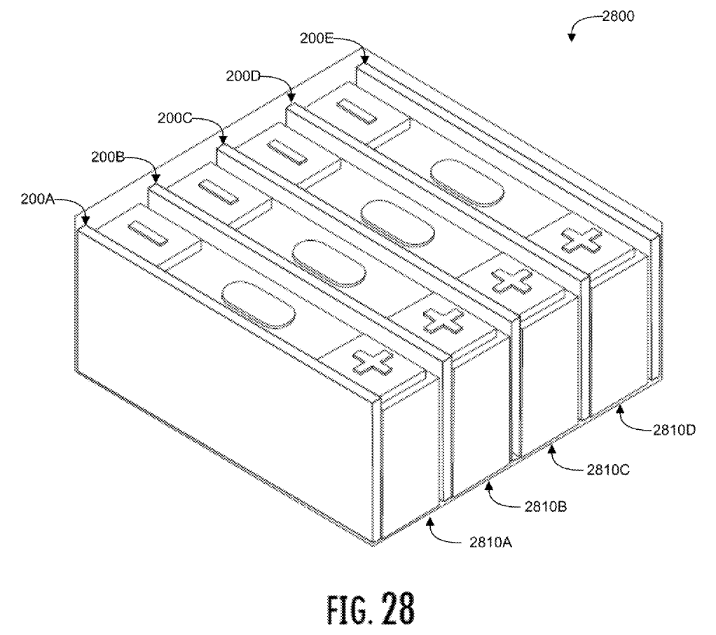

FIG. 28 is a perspective view of a first battery system in accordance with various example embodiments of the present disclosure. The illustrated view depicts a battery 2800 comprising a plurality of battery cells arranged in a stacked configuration within a housing structure. The battery 2800 includes a battery cell 2810A, a battery cell 2810B, a battery cell 2810C, and a battery cell 2810D positioned in a stacked arrangement along a compression axis.

The battery 2800 includes a compression pad 200A positioned between the battery cell 2810A and the battery cell 2810B. A compression pad 200B is positioned between the battery cell 2810B and the battery cell 2810C. A compression pad 200C is positioned between the battery cell 2810C and the battery cell 2810D. The battery 2800 further includes a compression pad 200D positioned adjacent to the battery cell 2810A and a compression pad 200E positioned adjacent to the battery cell 2810D, wherein the compression pad 200D and the compression pad 200E are positioned at opposing ends of the stacked battery cell arrangement. The battery cells are arranged such that adjacent battery cells share a common orientation within the stacked configuration. The housing structure surrounds the stacked battery cells and provides structural containment for the battery 2800 assembly.

The compression pad 200A, the compression pad 200B, the compression pad 200C, the compression pad 200D, and the compression pad 200E are each configured to accommodate dimensional changes of the battery cell 2810A, the battery cell 2810B, the battery cell 2810C, and the battery cell 2810D, such as during charging and discharging cycles. For example, in various embodiments the compression pads 200A-E may provide uniform pressure distribution across the flat surfaces of the battery cells during cell breathing, wherein the battery cells undergo expansion and contraction due to electrochemical processes. The interleaved springs of each compression pad 200A-E may distribute compressive forces uniformly across the battery cell surfaces to reduce pressure concentrations that may contribute to degradation mechanisms within one or more of the battery cells.

In various embodiments, the battery cell 2810A, the battery cell 2810B, the battery cell 2810C, and the battery cell 2810D may comprise prismatic battery cells or pouch battery cells. In various embodiments, the battery cells may be solid state battery cells. The compression pads 200A-E may be configured to accommodate the expansion characteristics associated with prismatic and pouch cell configurations, which may exhibit non-uniform expansion patterns during charging and discharging cycles.

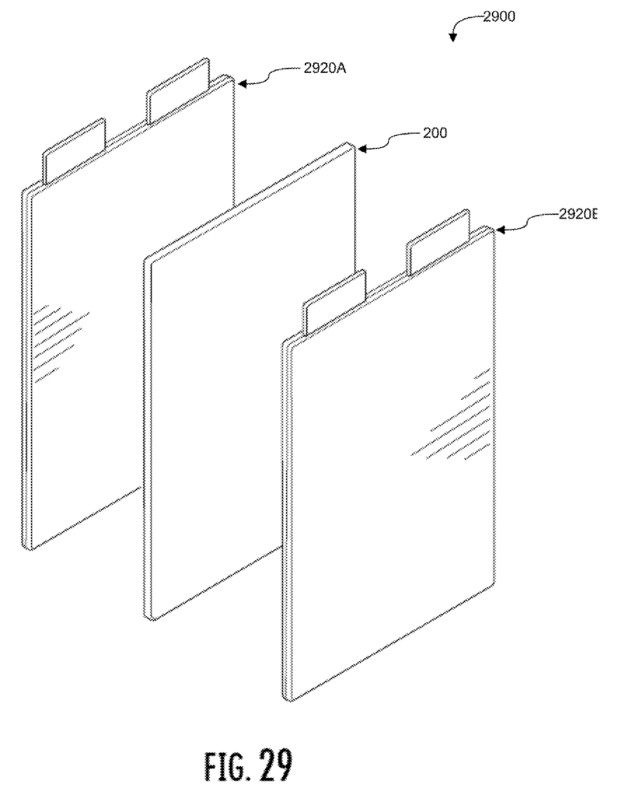

FIG. 29 is a perspective view of a portion of a second battery system in accordance with various example embodiments of the present disclosure. The illustrated view depicts an exploded portion battery module 2900 comprising a first battery cell 2920A and a second battery cell 2920B arranged in a stacked configuration with a compression pad 200 positioned between the first battery cell 2920A and the second battery cell 2920B. In various embodiments, the battery cells 2920 may be pouch battery cells as shown. It will be appreciated that the battery module 2900 may include many more battery cells and/or compression pads than those depicted.

The battery module 2900 includes the first battery cell 2920A positioned adjacent to the compression pad 200 along a first side of the compression pad 200. The second battery cell 2920B is positioned adjacent to the compression pad 200 along an opposing second side of the compression pad 200. The compression pad 200 is configured to separate the first battery cell 2920A and the second battery cell 2920B within the battery module 2900.

The compression pad 200 includes a first multi-spring compression plate coupled with an opposing multi-spring compression plate, wherein the compression pad 200 is configured to accommodate dimensional changes of the first battery cell 2920A and the second battery cell 2920B during charging and discharging cycles. The battery module 2900 may include a plurality of battery cells, which may include one or more compression pads 200 between two adjacent battery cells.

The first battery cell 2920A and the second battery cell 2920B interact with the compression pad 200 such that when either the first battery cell 2920A or the second battery cell 2920B undergoes expansion during charging, the compression pad 200 receives the compression force and uniformly distributes the compression force across the surface of the compression pad 200. The interleaved springs of the compression pad 200 distribute compressive forces uniformly across the battery cell surfaces to reduce pressure concentrations that may contribute to degradation mechanisms within the first battery cell 2920A or the second battery cell 2920B. This may provide for any pressure received from one of the battery cells (e.g., 2920A) to be applied to an adjacent battery cell (e.g., 2920B) uniformly and not at a smaller location that may lead to compression on the adjacent battery cell (e.g., 2920B). Thus, a compression pad 200 may provide for an elongated life of a battery module 2900 and battery cells 2920A, 2920B. In various embodiments, the first battery cell 2920A and the second battery cell 2920B may comprise prismatic battery cells or pouch battery cells.

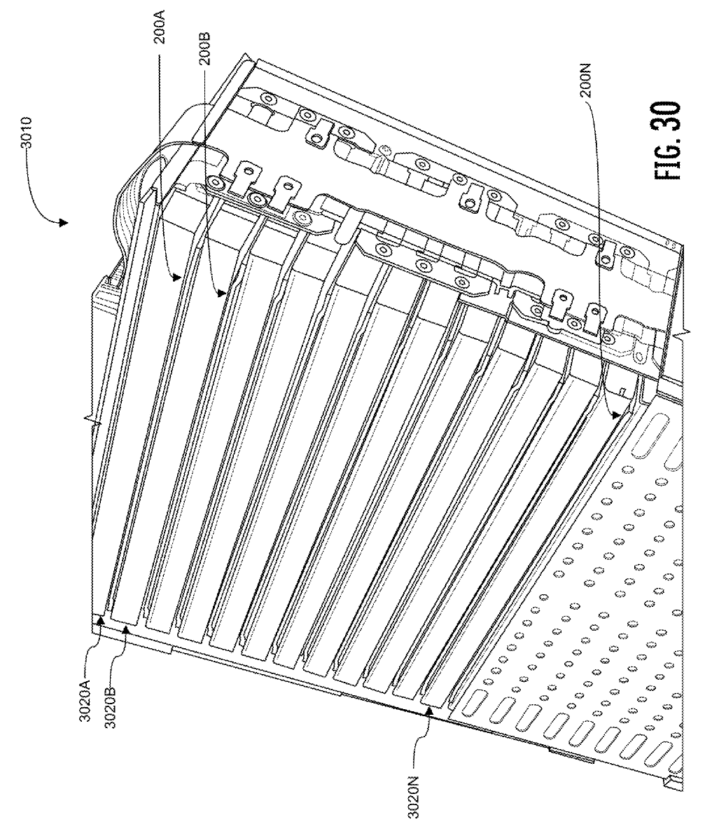

FIG. 30 is a perspective view of a portion of a third battery system in accordance with various example embodiments of the present disclosure. The illustrated view depicts a battery module 3010 comprising a plurality of battery cells arranged in a stacked configuration with compression pads positioned between adjacent battery cells.

The battery module 3010 includes a battery cell 3020A, a battery cell 3020B, to battery cell 3020N positioned in a stacked arrangement along an axis, which may be referred to as a compression axis. The battery module 3010 further includes a compression pad 200A positioned between the battery cell 3020A and the battery cell 3020B. A compression pad 200B is positioned between the battery cell 3020B and the battery cell 3020N. An nth compression pad 200N is positioned adjacent to the battery cell 3020N, wherein the nth compression pad 200N is positioned at an end of the stacked battery cell arrangement.

The compression pad 200A, the compression pad 200B, and the nth compression pad 200N are each configured to accommodate dimensional changes of the battery cell 3020A, the battery cell 3020B, and the battery cell 3020N during charging and discharging cycles. Each of the compression pad 200A, the compression pad 200B, and the nth compression pad 200N includes a first multi-spring compression plate coupled with an opposing multi-spring compression plate, wherein the compression pads are configured to provide uniform pressure distribution across the flat surfaces of the battery cells.

The battery cell 3020A, the battery cell 3020B, and the battery cell 3020N interact with the compression pad 200A, the compression pad 200B, and the nth compression pad 200N such that when any of the battery cells undergoes expansion during charging, the respective compression pad receives the compression force and uniformly distributes the compression force across the surface of the compression pad.

In various embodiments, the compression pads 200A-N may be positioned at intervals other than between every adjacent pair of battery cells within a battery module. For example, a compression pad may be positioned between every second battery cell, every third battery cell, every fifth battery cell, every tenth battery cell, or at other selected intervals within the stacked arrangement of battery cells 3020A-N. In various embodiments, the configuration of intervals may be based on, for example, factors such as the expected magnitude of dimensional changes during charging and discharging cycles, the overall length of the battery cell(s) along the compression axis, the desired balance between pressure distribution uniformity and component count, or the thermal management requirements of the battery system.

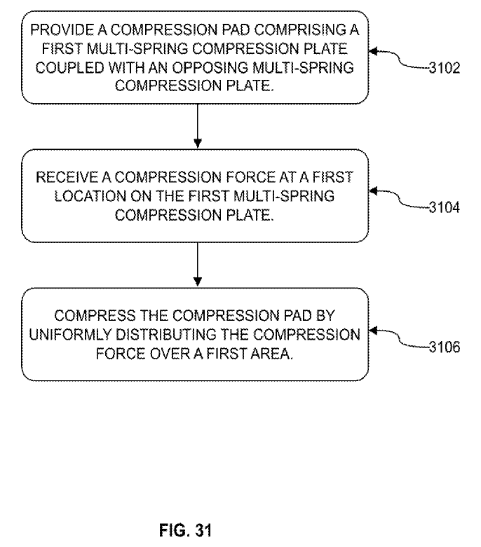

FIG. 31 illustrates an example sequence diagram of operations for use of a method for using a multi-spring compression plate in accordance with various example embodiments of the present disclosure. The sequence diagram illustrates the operational flow for utilizing a compression pad within a battery system.

At operation 3102, provide a compression pad (e.g. 200) comprising a first multi-spring compression plate (e.g., 210A) coupled with an opposing multi-spring compression plate (e.g., 210B).

The first multi-spring compression plate includes a first compression plate body that includes a first plurality of elongate spring bodies. Each elongate spring body of the first plurality of elongate spring bodies includes a spring perimeter surface that is structured to define at least part of an aperture perimeter of a spring shaping aperture 140 extending through the first compression plate body. A first plurality of support regions is defined between adjacent pairs of the first plurality of elongate spring bodies. One or more elongate stiffening ribs are defined by the first compression plate body within one or more of the first plurality of support regions. The one or more elongate stiffening ribs extend along a first direction at least partially between a first adjacent pair of the first plurality of elongate spring bodies.

The opposing multi-spring compression plate includes a second compression plate body. The second compression plate body includes a second plurality of elongate spring bodies. Each elongate spring body of the second plurality of elongate spring bodies includes a spring perimeter surface that is structured to define at least part of an aperture perimeter of a spring shaping aperture extending through the second compression plate body. A second plurality of support regions is defined between adjacent pairs of the second plurality of elongate spring bodies. One or more elongate stiffening ribs are defined by the second compression plate body within one or more of the second plurality of support regions. The one or more elongate stiffening ribs extend along the first direction at least partially between a first adjacent pair of the second plurality of elongate spring bodies.

At operation 3104, receive a compression force at a first location on the first multi-spring compression plate (e.g., 210A). The compression force may be received from a compression force source, such as a battery cell undergoing expansion during charging or discharging cycles. The compression force acts upon the first multi-spring compression plate at the first location. This engages the plurality of springs of both the multi-spring compression plate and the multi-spring compression plate and initiates the compression response of the compression pad.

At operation 3106, compress the compression pad (e.g., 200) by uniformly distributing the compression force over a first area. The interleaved arrangement of the elongate spring bodies of the first multi-spring compression plate and the opposing multi-spring compression plate facilitates the uniform distribution of the compression force across the compression pad.

### Additional Example Embodiments

Hereinafter, various characteristics of certain example embodiments will be highlighted in a set of numbered clauses or paragraphs. These characteristics are not to be interpreted as being limiting on the invention or inventive concept, but are provided merely as a recitation of some characteristics as described herein, without suggesting a particular order of importance or relevancy of such example characteristics.

Clause 1. A multi-spring compression plate comprising: a compression plate body comprising: a plurality of elongate spring bodies, wherein each elongate spring body of the plurality of elongate spring bodies comprises a spring perimeter surface that is structured to define at least part of an aperture perimeter of a spring shaping aperture extending through the compression plate body; a plurality of support regions defined between adjacent pairs of the plurality of elongate spring bodies; and one or more elongate stiffening ribs defined by the compression plate body within one or more of the plurality of support regions extending along a first direction at least partially between a first adjacent pair of the plurality of elongate spring bodies.

Clause 2. The multi-spring compression plate of Clause 1, wherein the compression plate body further comprises: one or more elongate stiffening cross-ribs defined by the compression plate body within the plurality of support regions, wherein each of the one or more elongate stiffening cross-ribs extends along a second direction that is transverse to the first direction at least partially between a second adjacent pair of the plurality of elongate spring bodies.

Clause 3. The multi-spring compression plate of any of the aforementioned Clauses, wherein each elongate spring body extends from the compression plate body proximate a support surface of the compression plate body, and wherein each elongate spring body defines a spring compression angle relative to its respective support surface, and wherein the spring compression angle is structured to define compressive engagement between each elongate spring body and a reciprocally aligned elongate stiffening rib or elongate stiffening cross-rib of an opposing multi-spring compression plate.

Clause 4. The multi-spring compression plate of any of the aforementioned Clauses, wherein each elongate spring body defines an elongate stiffening rib-engagement surface configured to slideably engage a reciprocally aligned elongate stiffening rib or elongate stiffening cross-rib of an opposing multi-spring compression plate.

Clause 5. The multi-spring compression plate of any of the aforementioned Clauses, wherein, for each of the plurality of elongate spring bodies, the aperture perimeter of the spring shaping aperture defines a u-shaped spring shaping aperture with a concave aperture perimeter portion.

Clause 6. The multi-spring compression plate of any of the aforementioned Clauses, wherein one or more of the plurality of elongate spring bodies is configured with the spring perimeter surface structured to define a first shaped spring aperture of a first u-shaped spring aperture and a first elongate spring body having a first width, a first length, and a spring compression angle of a first spring compression angle; and wherein one or more of the plurality of elongate spring bodies is configured with the spring perimeter surface structured to define a second shaped spring aperture of a second u-shaped spring aperture and a second elongate spring body having a second width, a first length, and a spring compression angle of a first spring compression angle.

Clause 7. The multi-spring compression plate of any of the aforementioned Clauses, wherein the multi-spring compression plate and an opposing ribbed multi-spring compression plate are configured into a compression pad.

Clause 8. A compression pad comprising: a first multi-spring compression plate coupled with an opposing multi-spring compression plate; wherein the first multi-spring compression plate comprises a first compression plate body that comprises: a first plurality of elongate spring bodies, wherein each elongate spring body of the first plurality of elongate spring bodies comprises a spring perimeter surface that is structured to define at least part of an aperture perimeter of a spring shaping aperture extending through the first compression plate body; a first plurality of support regions defined between adjacent pairs of the first plurality of elongate spring bodies; one or more elongate stiffening ribs defined by the first compression plate body within one or more of the first plurality of support regions extending along a first direction at least partially between a first adjacent pair of the first plurality of elongate spring bodies; wherein the opposing multi-spring compression plate comprises a second compression plate body that comprises: a second plurality of elongate spring bodies, wherein each elongate spring body of the second plurality of elongate spring bodies comprises a spring perimeter surface that is structured to define at least part of an aperture perimeter of a spring shaping aperture extending through the second compression plate body; a second plurality of support regions defined between adjacent pairs of the second plurality of elongate spring bodies; and one or more elongate stiffening ribs defined by the second compression plate body within one or more of the second plurality of support regions extending along the first direction at least partially between a first adjacent pair of the second plurality of elongate spring bodies.

Clause 9. The compression pad of Clause 8, wherein the first compression plate body further comprises: one or more elongate stiffening cross-ribs defined by the first compression plate body within the first plurality of support regions, wherein each of the one or more elongate stiffening cross-ribs extends along a second direction that is transverse to the first direction at least partially between a second adjacent pair of the first plurality of elongate spring bodies.

Clause 10. The compression pad of any of Clauses 8-9, wherein each elongate spring body of the first multi-spring compression plate extends from the first compression plate body proximate a support surface of the first compression plate body, and wherein each elongate spring body defines a spring compression angle relative to its respective support surface, and wherein the spring compression angle is structured to define compressive engagement between each elongate spring body and a reciprocally aligned one of the one or more elongate stiffening ribs defined by the second compression plate body or an elongate stiffening cross-rib of the second compression plate body.

Clause 11. The compression pad of any of Clauses 8-10, wherein each elongate spring body of the first multi-spring compression plate defines an elongate stiffening rib-engagement surface configured to slideably engage a reciprocally aligned one of the one or more elongate stiffening ribs defined by the second compression plate body or an elongate stiffening cross-rib of the second compression plate body.

Clause 12. The compression pad of any of Clauses 8-11, wherein, for each of the first plurality of elongate spring bodies of the first multi-spring compression plate, the aperture perimeter of the spring shaping aperture defines a u-shaped spring shaping aperture with a concave aperture perimeter portion.

Clause 13. The compression pad of any of Clauses 8-12, wherein one or more of the first plurality of elongate spring bodies of the first multi-spring compression plate is configured with the spring perimeter surface structured to define a first shaped spring aperture of a first u-shaped spring aperture and a first elongate spring body having a first width, a first length, and a spring compression angle of a first spring compression angle; and wherein one or more of the first plurality of elongate spring bodies of the first multi-spring compression plate is configured with the spring perimeter surface structured to define a second shaped spring aperture of a second u-shaped spring aperture and a second elongate spring body having a second width, a first length, and a spring compression angle of a first spring compression angle.

Clause 14. The compression pad of any of Clauses 8-13, wherein the compression pad separates a first battery cell and a second battery cell of a battery module.

Clause 15. A method comprising: providing a compression pad comprising a first multi-spring compression plate coupled with an opposing multi-spring compression plate; wherein the first multi-spring compression plate comprises a first compression plate body that comprises: a first plurality of elongate spring bodies, wherein each elongate spring body of the first plurality of elongate spring bodies comprises a spring perimeter surface that is structured to define at least part of an aperture perimeter of a spring shaping aperture extending through the first compression plate body; a first plurality of support regions defined between adjacent pairs of the first plurality of elongate spring bodies; one or more elongate stiffening ribs defined by the first compression plate body within one or more of the first plurality of support regions extending along a first direction at least partially between a first adjacent pair of the first plurality of elongate spring bodies; wherein the opposing multi-spring compression plate comprises a second compression plate body that comprises: a second plurality of elongate spring bodies, wherein each elongate spring body of the second plurality of elongate spring bodies comprises a spring perimeter surface that is structured to define at least part of an aperture perimeter of a spring shaping aperture extending through the second compression plate body; a second plurality of support regions defined between adjacent pairs of the second plurality of elongate spring bodies; and one or more elongate stiffening ribs defined by the second compression plate body within one or more of the second plurality of support regions extending along the first direction at least partially between a first adjacent pair of the second plurality of elongate spring bodies; receiving a compression force at a first location on the first multi-spring compression plate; and compressing the compression pad by uniformly distributing the compression force over a first area.

Clause 16. The method of Clause 15, wherein the first compression plate body further comprises: one or more elongate stiffening cross-ribs defined by the first compression plate body within the first plurality of support regions, wherein each of the one or more elongate stiffening cross-ribs extends along a second direction that is transverse to the first direction at least partially between a second adjacent pair of the first plurality of elongate spring bodies.

Clause 17. The method of any of Clauses 15-16, wherein each elongate spring body of the first multi-spring compression plate extends from the first compression plate body proximate a support surface of the first compression plate body, and wherein each elongate spring body defines a spring compression angle relative to its respective support surface, and wherein the spring compression angle is structured to define compressive engagement between each elongate spring body and a reciprocally aligned one of the one or more elongate stiffening ribs defined by the second compression plate body or an elongate stiffening cross-rib of the second compression plate body.

Clause 18. The method of any of Clauses 15-17, wherein each elongate spring body of the first compression plate body defines an elongate stiffening rib-engagement surface configured to slideably engage a reciprocally aligned one of the one or more elongate stiffening ribs defined by the second compression plate body or an elongate stiffening cross-rib of the second compression plate body.

Clause 19. The method of any of Clauses 15-18, wherein, for each of the first plurality of elongate spring bodies of the first multi-spring compression plate, the aperture perimeter of the spring shaping aperture defines a u-shaped spring shaping aperture with a concave aperture perimeter portion.

Clause 20. The method of any of Clauses 15-19, wherein the compression pad separates a first battery cell and a second battery cell of a battery module; and wherein the compression force is received by either of the first battery cell or the second battery cell in response to the first battery cell or the second battery cell being charged or discharged.

### Conclusion

While this specification contains many specific implementation details, these should not be construed as limitations on the scope of any disclosures or of what may be claimed, but rather as descriptions of features specific to particular embodiments of particular disclosures. Certain features described herein in the context of separate embodiments can also be implemented in combination in a single embodiment. Conversely, various features described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results.

The separation of various components in the embodiments described above should not be understood as requiring such separation in all embodiments, and it should be understood that the described components and systems can generally be integrated together in a single system, apparatus, or product. Particular embodiments of the subject matter have been described. Other embodiments are within the scope of the following claims.

The operations or actions recited in the claims can in some cases be performed in a different order and can still achieve desirable results. The operations or actions depicted in the accompanying figures do not necessarily require the particular order shown, or sequential order, to achieve desirable results. Similarly, while operations are depicted in the drawings in a particular order, this should not be understood as requiring that such operations be performed in the particular order shown or in incremental order, or that all illustrated operations be performed, to achieve desirable results, unless described otherwise.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A multi-spring compression plate comprising:
a compression plate body comprising:
a plurality of elongate spring bodies, wherein each elongate spring body of the plurality of elongate spring bodies comprises a spring perimeter surface that is structured to define at least part of an aperture perimeter of a spring shaping aperture extending through the compression plate body;
a plurality of support regions defined between adjacent pairs of the plurality of elongate spring bodies; and
one or more elongate stiffening ribs defined by the compression plate body within one or more of the plurality of support regions extending along a first direction at least partially between a first adjacent pair of the plurality of elongate spring bodies.

2. The multi-spring compression plate of claim 1, wherein the compression plate body further comprises:
one or more elongate stiffening cross-ribs defined by the compression plate body within the plurality of support regions, wherein each of the one or more elongate stiffening cross-ribs extends along a second direction that is transverse to the first direction at least partially between a second adjacent pair of the plurality of elongate spring bodies.

3. The multi-spring compression plate of claim 1, wherein each elongate spring body extends from the compression plate body proximate a support surface of the compression plate body, and wherein each elongate spring body defines a spring compression angle relative to its respective support surface, and wherein the spring compression angle is structured to define compressive engagement between each elongate spring body and a reciprocally aligned elongate stiffening rib or elongate stiffening cross-rib of an opposing multi-spring compression plate.

4. The multi-spring compression plate of claim 1, wherein each elongate spring body defines an elongate stiffening rib-engagement surface configured to slideably engage a reciprocally aligned elongate stiffening rib or elongate stiffening cross-rib of an opposing multi-spring compression plate.

5. The multi-spring compression plate of claim 1, wherein, for each of the plurality of elongate spring bodies, the aperture perimeter of the spring shaping aperture defines a u-shaped spring shaping aperture with a concave aperture perimeter portion.

6. The multi-spring compression plate of claim 1, wherein one or more of the plurality of elongate spring bodies is configured with the spring perimeter surface structured to define a first shaped spring aperture of a first u-shaped spring aperture and a first elongate spring body having a first width, a first length, and a spring compression angle of a first spring compression angle; and
wherein one or more of the plurality of elongate spring bodies is configured with the spring perimeter surface structured to define a second shaped spring aperture of a second u-shaped spring aperture and a second elongate spring body having a second width, a first length, and a spring compression angle of a first spring compression angle.

7. The multi-spring compression plate of claim 1, wherein the multi-spring compression plate and an opposing ribbed multi-spring compression plate are configured into a compression pad.

8. A compression pad comprising:
a first multi-spring compression plate coupled with an opposing multi-spring compression plate;
wherein the first multi-spring compression plate comprises a first compression plate body that comprises:
a first plurality of elongate spring bodies, wherein each elongate spring body of the first plurality of elongate spring bodies comprises a spring perimeter surface that is structured to define at least part of an aperture perimeter of a spring shaping aperture extending through the first compression plate body;
a first plurality of support regions defined between adjacent pairs of the first plurality of elongate spring bodies;
one or more elongate stiffening ribs defined by the first compression plate body within one or more of the first plurality of support regions extending along a first direction at least partially between a first adjacent pair of the first plurality of elongate spring bodies;
wherein the opposing multi-spring compression plate comprises a second compression plate body that comprises:
a second plurality of elongate spring bodies, wherein each elongate spring body of the second plurality of elongate spring bodies comprises a spring perimeter surface that is structured to define at least part of an aperture perimeter of a spring shaping aperture extending through the second compression plate body;
a second plurality of support regions defined between adjacent pairs of the second plurality of elongate spring bodies; and
one or more elongate stiffening ribs defined by the second compression plate body within one or more of the second plurality of support regions extending along the first direction at least partially between a first adjacent pair of the second plurality of elongate spring bodies.

9. The compression pad of claim 8, wherein the first compression plate body further comprises:
one or more elongate stiffening cross-ribs defined by the first compression plate body within the first plurality of support regions, wherein each of the one or more elongate stiffening cross-ribs extends along a second direction that is transverse to the first direction at least partially between a second adjacent pair of the first plurality of elongate spring bodies.

10. The compression pad of claim 8, wherein each elongate spring body of the first multi-spring compression plate extends from the first compression plate body proximate a support surface of the first compression plate body, and wherein each elongate spring body defines a spring compression angle relative to its respective support surface, and wherein the spring compression angle is structured to define compressive engagement between each elongate spring body and a reciprocally aligned one of the one or more elongate stiffening ribs defined by the second compression plate body or an elongate stiffening cross-rib of the second compression plate body.

11. The compression pad of claim 8, wherein each elongate spring body of the first multi-spring compression plate defines an elongate stiffening rib-engagement surface configured to slideably engage a reciprocally aligned one of the one or more elongate stiffening ribs defined by the second compression plate body or an elongate stiffening cross-rib of the second compression plate body.

12. The compression pad of claim 8, wherein, for each of the first plurality of elongate spring bodies of the first multi-spring compression plate, the aperture perimeter of the spring shaping aperture defines a u-shaped spring shaping aperture with a concave aperture perimeter portion.

13. The compression pad of claim 8, wherein one or more of the first plurality of elongate spring bodies of the first multi-spring compression plate is configured with the spring perimeter surface structured to define a first shaped spring aperture of a first u-shaped spring aperture and a first elongate spring body having a first width, a first length, and a spring compression angle of a first spring compression angle; and
wherein one or more of the first plurality of elongate spring bodies of the first multi-spring compression plate is configured with the spring perimeter surface structured to define a second shaped spring aperture of a second u-shaped spring aperture and a second elongate spring body having a second width, a first length, and a spring compression angle of a first spring compression angle.

14. The compression pad of claim 8, wherein the compression pad separates a first battery cell and a second battery cell of a battery module.

15. A method comprising:
providing a compression pad comprising a first multi-spring compression plate coupled with an opposing multi-spring compression plate;
wherein the first multi-spring compression plate comprises a first compression plate body that comprises:
a first plurality of elongate spring bodies, wherein each elongate spring body of the first plurality of elongate spring bodies comprises a spring perimeter surface that is structured to define at least part of an aperture perimeter of a spring shaping aperture extending through the first compression plate body;
a first plurality of support regions defined between adjacent pairs of the first plurality of elongate spring bodies;
one or more elongate stiffening ribs defined by the first compression plate body within one or more of the first plurality of support regions extending along a first direction at least partially between a first adjacent pair of the first plurality of elongate spring bodies;
wherein the opposing multi-spring compression plate comprises a second compression plate body that comprises:
a second plurality of elongate spring bodies, wherein each elongate spring body of the second plurality of elongate spring bodies comprises a spring perimeter surface that is structured to define at least part of an aperture perimeter of a spring shaping aperture extending through the second compression plate body;
a second plurality of support regions defined between adjacent pairs of the second plurality of elongate spring bodies; and
one or more elongate stiffening ribs defined by the second compression plate body within one or more of the second plurality of support regions extending along the first direction at least partially between a first adjacent pair of the second plurality of elongate spring bodies;
receiving a compression force at a first location on the first multi-spring compression plate; and
compressing the compression pad by uniformly distributing the compression force over a first area.

16. The method of claim 15, wherein the first compression plate body further comprises:
one or more elongate stiffening cross-ribs defined by the first compression plate body within the first plurality of support regions, wherein each of the one or more elongate stiffening cross-ribs extends along a second direction that is transverse to the first direction at least partially between a second adjacent pair of the first plurality of elongate spring bodies.

17. The method of claim 15, wherein each elongate spring body of the first multi-spring compression plate extends from the first compression plate body proximate a support surface of the first compression plate body, and wherein each elongate spring body defines a spring compression angle relative to its respective support surface, and wherein the spring compression angle is structured to define compressive engagement between each elongate spring body and a reciprocally aligned one of the one or more elongate stiffening ribs defined by the second compression plate body or an elongate stiffening cross-rib of the second compression plate body.

18. The method of claim 15, wherein each elongate spring body of the first compression plate body defines an elongate stiffening rib-engagement surface configured to slideably engage a reciprocally aligned one of the one or more elongate stiffening ribs defined by the second compression plate body or an elongate stiffening cross-rib of the second compression plate body.

19. The method of claim 15, wherein, for each of the first plurality of elongate spring bodies of the first multi-spring compression plate, the aperture perimeter of the spring shaping aperture defines a u-shaped spring shaping aperture with a concave aperture perimeter portion.

20. The method of claim 15, wherein the compression pad separates a first battery cell and a second battery cell of a battery module; and wherein the compression force is received by either of the first battery cell or the second battery cell in response to the first battery cell or the second battery cell being charged or discharged.
